(19) United States
(12) Patent Application Publication
(10) Pub. No.: US 2022/0403094 A1
(43) Pub. Date: Dec. 22, 2022

(54) POLYSILOXANE-FUNCTIONALIZED POLYURETHANES FOR BOOSTING THE HYDROPHOBICITY OF SURFACES

(71) Applicant: Covestro Intellectual Property GmbH & Co. KG, Leverkusen (DE)

(72) Inventors: Florian GOLLING, Dortmund (DE); Andreas HECKING, Langenfeld (DE); Nadine DER, Monheim (DE); Dieter MAGER, Leverkusen (DE)

(21) Appl. No.: 17/774,507

(22) PCT Filed: Nov. 9, 2020
(86) PCT No.: PCT/EP2020/081411

§ 371 Date: May 5, 2022

(30) Foreign Application Priority Data
Nov. 15, 2019 (EP) 19209291.4

(51) Int. Cl. C08G 18/61; C08G 18/10; C08G 18/73; C08G 18/75; C09D 175/04

(52) U.S. Cl. CPC C08G 18/61; C08G 18/10; C08G 18/73; C08G 18/755; C09D 175/04

(57) ABSTRACT

The present invention relates to an NCO-terminated polysiloxane prepolymer of the general formula (I) [(Q)_{q}]-(M)ₘ-(P)ₚ—(R)ᵣ]ₜ, in which R, P, M, Q, r, p, m, q and t are defined as follows: R in each case independently is at least one polyisocyanate unit and/or at least one diisocyanate unit, P in each case independently is at least one polyol unit, M in each case independently is at least one diisocyanate unit and/or at least one polyisocyanate unit, Q is at least one polysiloxane unit, r in each case independently is a number from 1 to 10, p in each case independently is a number from 1 to 10, m in each case independently is a number from 1 to 10, q in each case independently is a number from 1 to 10, t is an integer from 2 to 5, and the M units present are attached directly to the unit Q; to a process for producing said prepolymer, and to use as curing agent in a coating formulation.

The present invention relates to an NCO-terminated polysiloxane prepolymer, to a process for the production thereof, to a formulation comprising the NCO-terminated polysiloxane prepolymer, and to the use of this NCO-terminated polysiloxane prepolymer in a paint formulation.

It is known that NCO-terminated prepolymers can be used as curing components in polyurethane paint or coating systems. These prepolymers are generally obtained by reacting polyols with di- or polyisocyanates. As a curing component, the prepolymers then react in the paint or coating system with other polyols, for example with polyacrylate polyols, to form the corresponding polyurethanes. It is desirable here for the surfaces of these coating materials to have hydrophobic properties, for example in order to minimize the adhesion of water and/or dirt.

The incorporation of siloxane units into the coating materials in order to increase the hydrophobicity of the corresponding surface is already known from the prior art.

WO 2018/146016 A1 describes copolymers comprising at least three structural units, firstly a component having at least one biuret or isocyanurate substructure, a polysiloxane as a further component, and as a third component a further hydrocarbon containing at least six carbon atoms that is different from the second component. The copolymers are used to make textiles hydrophobic.

WO 2017/151621 A1 discloses non-isocyanate-functionalized, siloxane-modified glycidyl carbamates for use in coating materials. The glycidyl carbamates are obtained by reacting organic polyisocyanates, glycidol, and at least one bis(hydroxyalkyl)-terminated polydimethylsiloxane.

Document US 2008/0213599 A1 describes a polymeric material obtained through reaction of a mixture comprising amino-functional polyorganosiloxanes, polyisocyanates, and polyols. This material can be used as an antifouling coating agent.

US 2014/0275410 A1 discloses an isocyanate-terminated polysiloxane copolymer that can be used as a curing agent or co-reactant in coating materials. To produce this copolymer, a methoxy-functionalized polysiloxane such as methyl phenyl polysiloxane is reacted with a polyisocyanate to obtain the desired copolymer. In coating materials, this copolymer then reacts with isocyanate-reactive groups to form corresponding polyurethanes.

WO 2014/149331 A1 likewise relates to an isocyanate-terminated polysiloxane that can be used as a curing agent in coating systems. To produce this polysiloxane, a methoxy-functionalized polysiloxane is likewise hydrolyzed and then reacted with a polyisocyanate.

In the systems known from the prior art, the compatibility of the siloxane structural units in the paint system needs to be improved in some cases. A further problem is the accumulation of siloxane chains at the surface of the coating. If the siloxane chains are present mostly on the surface of the coating, contact with water and scratching of the surface can lead to stripping of the siloxane layer, resulting in loss of the desired surface hydrophobization afforded by the siloxane chains. The polysiloxane structural units present should therefore have a sufficiently strong attachment to the matrix. In addition, the strength of the surface hydrophobization itself can be increased.

The object of the present invention is therefore to produce a polysiloxane-based curing agent for a polyurethane-based coating material that has greater surface hydrophobicity than coatings known from the prior art. In addition, this hydrophobicity should be unaffected by scratching the surface or by the action of water on the surface. A further object of the present invention is therefore to provide correspondingly suitable polysiloxane structural units for use as curing agents in coating materials having particularly high compatibility with and attachment to the matrix.

These objects are according to the invention achieved by the NCO-terminated polysiloxane prepolymer of the general formula (I)

[(Q)_{q}]-(M)ₘ-(P)ₚ—(R)ᵣ]ₜ (I),

where R, P, M, Q, r, p, m, q, and t are defined as follows
R in each case independently at least one polyisocyanate unit and/or at least one diisocyanate unit,
P in each case independently at least one polyol unit,
M in each case independently at least one diisocyanate unit and/or at least one polyisocyanate unit,
Q at least one polysiloxane unit,
r in each case independently a number from 1 to 10,
p in each case independently a number from 1 to 10,
m in each case independently a number from 1 to 10,
q in each case independently a number from 1 to 10,
t an integer from 2 to 5, and

the units M present are attached directly to the unit Q.

The objects mentioned are additionally achieved by a process for preparing an NCO-terminated polysiloxane prepolymer of the invention, comprising at least the following steps:
(A) reacting at least one polysiloxane polyol with at least one diisocyanate and/or at least one polyisocyanate so as to obtain at least one NCO-terminated polysiloxane,
(B) optionally removing the excess of the at least one diisocyanate or at least one polyisocyanate,
(C) reacting the at least one NCO-terminated polysiloxane from step (A) or (B) with at least one polyol,
(D) reacting the product obtained in step (C) with at least one polyisocyanate or at least one diisocyanate so as to obtain the NCO-terminated polysiloxane prepolymer,

and also by the formulation of the invention comprising at least one NCO-terminated polysiloxane prepolymer of the invention, and through the use of the NCO-terminated polysiloxane prepolymer of the invention as a curing agent in a paint formulation.

The present invention is described in detail hereinbelow.

The present invention relates to the NCO-terminated polysiloxane prepolymer of the general formula (I)

[(Q)_{q}]-(M)ₘ-(P)ₚ—(R)ᵣ]ₜ (I),

where R, P, M, Q, r, p, m, q, and t are as defined above.

The prepolymer of general formula (I) of the invention is NCO-terminated. In the context of the present invention, “NCO-terminated” means that preferably 2% to 24% by weight, particularly preferably 4% to 15% by weight, very particularly preferably 5% to 12% by weight, of the terminal functional groups are isocyanate groups, i.e. NCO groups.

The prepolymer of general formula (I) of the invention can in principle have any molecular weight known to those skilled in the art. In a preferred embodiment of the present invention, the number-weighted molecular weight Mn of the prepolymer of the invention is 445 to 8500 g/mol, particularly preferably 550 to 6000 g/mol, very particularly preferably 600 to 5500 g/mol.

In a preferred embodiment of the present invention, the degree of branching of the prepolymer of the invention is 2 to 14, particularly preferably 3 to 12, very particularly preferably 4 to 10.

In general formula (I), R, P, M, Q, r, p, m, q, and t more particularly have the meanings shown below. In general formula (I), M in each case independently denotes at least one diisocyanate unit and/or at least one polyisocyanate unit. The units M present are according to the invention each attached directly to the unit Q. It is according to the invention possible for 2 to 5 diisocyanate and/or polyisocyanate units M, preferably 2, 3, 4 or 5 diisocyanate and/or polyisocyanate units M, to be attached to the polysiloxane unit Q. In a very particularly preferred embodiment, two diisocyanate and/or polyisocyanate units M are attached to the polysiloxane unit Q.

According to the invention, M in general formula (I) particularly preferably in each case independently denotes at least one diisocyanate unit, i.e. there are 2 to 5, preferably 2, 3, 4 or 5, very particularly preferably 2, diisocyanate units M attached to the polysiloxane unit Q. These may according to the invention be identical or different; preferably, the diisocyanate units M attached to the polysiloxane unit Q are identical.

In the context of the present invention, “unit” means that the structural unit present in the compound of the general formula (I) is derived from the reactive compounds described hereinbelow. If, for example, a diisocyanate is reacted with a diol or polyol, a urethane group is formed from an isocyanate group and a hydroxy group. The remainder of the employed compounds, for example the six methylene groups of hexamethylene diisocyanate, remain however unchanged. “Unit” in the context of the present invention is accordingly understood as meaning both the parts of the compounds that are not involved in the reaction and also the functional groups, for example a urethane group, that are formed by the reaction. In the context of the present invention, the corresponding unit is always derived from the compounds used in the synthesis.

In the context of the present invention, “in each case independently” means that if the corresponding unit occurs more than once in general formula (I), the units are identical or different and are in each case selected from the group of the units possible in the particular case. It is according to the invention also possible for a mixture of compounds of the general formula (I) to be present, various of the possible units being present in the individual molecules.

The at least one diisocyanate unit M is according to the invention preferably derived from a diisocyanate. Diisocyanates used as unit M are preferably selected from the group consisting of organic aliphatic, cycloaliphatic, araliphatic, aromatic diisocyanates and mixtures thereof. Preference is given to using as unit M aliphatic and/or cycloaliphatic diisocyanates.

Particular preference is given to using as unit M according to the invention diisocyanates selected from the group consisting of butane 1,4-diisocyanate, pentane 1,5-diisocyanate (pentamethylene diisocyanate, PDI), hexane 1,6-diisocyanate (hexamethylene diisocyanate, HDI), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′-, and 4,4′-MDI or mixtures thereof), diisocyanatomethylbenzene (tolylene 2,4- and 2,6-diisocyanate, TDI) and technical mixtures of the two isomers and also 1,3- and/or 1,4-bis(isocyanatomethyl)benzene (XDI), 3,3′-dimethylbiphenyl 4,4′-diisocyanate (TODI), 1,4-para-phenylene diisocyanate (PPDI), and also cyclohexyl diisocyanate (CHDI) and mixtures thereof.

The diisocyanate present as unit M according to the invention is very particularly preferably selected from the group consisting of hexane 1,6-diisocyanate (hexamethylene diisocyanate, HDI), pentane 1,5-diisocyanate (pentamethylene diisocyanate, PDI), 3,5,5-trimethyl-1-isocyanato-3-isocyanatomethylcyclohexane (isophorone diisocyanate, IPDI), 4,4′-methylenebis(cyclohexyl isocyanate) (H12MDI), and mixtures thereof.

In a less preferred embodiment according to the invention, M in general formula (I) denotes at least one polyisocyanate unit. The polyisocyanate used for this purpose can be selected from the group consisting of aliphatic, cycloaliphatic, araliphatic, aromatic polyisocyanates, and mixtures thereof.

Examples of polyisocyanates present as unit M are selected from the group consisting of triisocyanates such as 3,5,5-trimethyl-1-isocyanato-3-isocyanatomethylcyclohexane or higher-molecular-weight oligomers having biuret, uretdione, isocyanurate, iminooxadiazinedione, allophanate, urethane- and/or carbodiimide/uretonimine structural units obtainable through reaction of di- or triisocyanates selected from the group consisting of butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′-, and 4,4′-MDI or mixtures thereof), diisocyanatomethylbenzene (tolylene 2,4- and 2,6-diisocyanate, TDI) and technical mixtures of the two isomers and also 1,3- and/or 1,4-bis(isocyanatomethyl)benzene (XDI), 3,3′-dimethylbiphenyl 4,4′-diisocyanate (TODI), 1,4-para-phenylene diisocyanate (PPDI), cyclohexyl diisocyanate (CHDI), and mixtures thereof.

In the compound of the general formula (I), P in each case independently denotes at least one polyol unit. The at least one polyol unit is according to the invention preferably derived from a polyol.

Polymeric polyols or low-molecular-weight polyols may according to the invention be present. The polyols P used may according to the invention be compounds that contain at least one Zerewitinoff-active group, for example a hydroxy or thiol group.

Polyols P particularly preferred according to the invention have an average OH or SH functionality of at least 1.5.

Polyols P preferred according to the invention are selected from the group consisting of diols, triols, tetraols, polyhydroxy compounds, and mixtures thereof.

Polyols particularly preferred as unit P are selected from the group consisting of ethane-1,2-diol, propane-1,3-diol, propane-1,2-diol, butane-1,4-diol, glycerol, trimethylolpropane, pentaerythritol, polyhydroxy compounds, and mixtures thereof.

Preference is according to the invention given to polyols P selected from the group consisting of polyether polyols, polyester polyols, polyurethane polyols, polysiloxane polyols, polycarbonate polyols, polybutadiene polyols, polyacrylate polyols, polymethacrylate polyols, copolymers of polyacrylate polyols and polymethacrylate polyols, and mixtures thereof.

In a preferred embodiment, the at least one polyol P is a polymeric polyol, in particular a polyhydroxy compound. The polyhydroxy compounds preferably have weight-average molecular weights Mw of greater than 500 g/mol, more preferably 800 to 100 000 g/mol, in particular 1000 to 50 000 g/mol, in each case measured by gel-permeation chromatography (GPC) against a polystyrene standard.

The polyhydroxy compounds preferably have an OH value of 30 to 400 mg KOH/g, in particular of 100 to 300 KOH/g. The hydroxyl value (OH value) indicates how many mg of potassium hydroxide are equivalent to the amount of acetic acid bound by 1 g of substance in the acetylation. In the determination, the sample is boiled with acetic anhydride/pyridine and the acid formed is titrated with potassium hydroxide solution (DIN 53240-2 2:2007-11).

The glass transition temperatures, measured with the aid of DSC measurements in accordance with DIN EN ISO 11357-2-2:2014-07, of the polyhydroxy compounds preferred according to the invention are preferably from −150 to 100° C., more preferably from −120 to 80° C.

Preference is according to the invention given to selecting the at least one polyol P from the group consisting of polyether polyols, polyester polyols, polyurethane polyols, polysiloxane polyols, polyacrylate polyols, and mixtures thereof.

The polyether polyols used with preference according to the invention can be obtained in a manner known per se by alkoxylation of suitable starter molecules with base catalysis or using double metal cyanide compounds (DMC compounds). Examples of suitable starter molecules for the preparation of polyether polyols are simple low-molecular-weight polyols, water, organic polyamines having at least two NH bonds, or any desired mixtures of such starter molecules.

Preferred starter molecules for preparation of polyether polyols by alkoxylation, in particular by the DMC method, are in particular simple polyols such as ethylene glycol, 1,3-propylene glycol, butane-1,4-diol, hexane-1,6-diol, neopentyl glycol, 2-ethylhexane-1,3-diol, glycerol, trimethylolpropane, pentaerythritol, and low-molecular-weight hydroxyl-containing esters of such polyols with dicarboxylic acids of the kind specified hereinbelow, or low-molecular-weight ethoxylation or propoxylation products of such simple polyols, or any desired mixtures of such modified or unmodified alcohols. Alkylene oxides suitable for the alkoxylation are in particular ethylene oxide and/or propylene oxide, which may be used in the alkoxylation in any desired order or also in a mixture.

Polyester polyols suitable according to the invention are described for example in EP-A-0 994 1 17 and EP-A-1 273 640. Polyester polyols can be prepared in a known manner by polycondensation of low-molecular-weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low-molecular-weight polyols, for example ethylene glycol, diethylene glycol, neopentyl glycol, hexanediol, butanediol, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. In addition, it is also possible for hydroxycarboxylic acid derivatives, for example lactic acid, cinnamic acid or hydroxycaproic acid, to undergo polycondensation to polyester polyols. However, it is also possible to use polyester polyols of oleochemical origin. Such polyester polyols can be prepared for example by full ring-opening of epoxidized triglycerides of an at least partly olefinically unsaturated fatty acid-containing fat mixture with one or more alcohols having 1 to 12 carbon atoms and subsequent partial transesterification of the triglyceride derivatives to alkyl ester polyols having 1 to 12 carbon atoms in the alkyl radical.

Polyurethane polyols suitable according to the invention are preferably prepared by reacting polyester polyol prepolymers with suitable di- or polyisocyanates and are described for example in EP-A-1 273 640 and EP-A-0 148 329. Preference is given to polyurethane polyols prepared using HDI, PDI, IPDI or H12MDI. The number-average molecular weight is preferably 500 to 2000 g/mol, the average functionality 2.0 to 3.5. Examples of suitable polyester polyols and suitable polyisocyanates are in each case mentioned above.

Polysiloxane polyols suitable according to the invention as polyol component P are described for example in WO-A-01/09260; the polysiloxane polyols cited therein can be used preferably in combination with further polyhydroxy compounds, in particular those having higher glass transition temperatures.

The polyacrylate polyols that are very particularly preferred according to the invention are generally copolymers of acrylic acid and/or methacrylic acid with olefinically unsaturated monomers containing hydroxy groups and preferably have weight-average molecular weights Mw of 270 to 22 000 g/mol, preferably 500 to 18 000 g/mol, more preferably 800 to 12 000, in each case measured by gel-permeation chromatography (GPC) against a polystyrene standard. The glass transition temperature of these copolymers is generally from −100 to 100° C., in particular from −50 to 80° C., in each case measured by DSC measurements in accordance with DIN EN ISO 11357-2-2:2014-07.

Preferred poly(meth)acrylate polyols have an OH value from 60 to 250 mg KOH/g, in particular from 70 to 200 mg KOH/g, and an acid value from 0 to 30 mg KOH/g. The acid value here indicates the number of mg of potassium hydroxide that is used for neutralization of 1 g of the respective compound (DIN EN ISO 2114:2002-06).

The preparation of suitable poly(meth)acrylate polyols is known per se to those skilled in the art. They are obtained by free-radical polymerization of acrylic acid and/or methacrylic acid with olefinically unsaturated monomers containing hydroxy groups and optionally other olefinically unsaturated monomers. Examples of suitable olefinically unsaturated compounds are ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or in particular cyclohexyl acrylate and/or cyclohexyl methacrylate.

Suitable olefinically unsaturated monomers having hydroxyl groups are in particular 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, and in particular 4-hydroxybutyl acrylate and/or 4-hydroxybutyl methacrylate.

Further monomer structural units used for the polyacrylate polyols may be vinyl aromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

Low-molecular-weight polyols P preferred according to the invention are derived for example from a polyhydric alcohol and/or ether or ester alcohol containing 2 to 14 carbon atoms, preferably 4 to 10 carbon atoms.

Preference is given to low-molecular-weight polyols P suitable according to the invention selected from the group consisting of ethane-1,2-diol, propane-1,2-diol, propane-1,3-diol, the isomeric butanediols, pentanediols, hexanediols, heptanediols, octanediols, decane-1,10-diol, dodecane-1,12-diol, cyclohexane-1,2-diol, cyclohexane-1,4-diol, cyclohexane-1,4-dimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), propane-1,2,3-triol, butane-1,2,4-triol, 1,1,1-trimethylolethane, hexane-1,2,6-triol, 1,1,1-trimethylolpropane (TMP), bis(2-hydroxyethyl)hydroquinone, 1,2,4-trihydroxycyclohexane, 1,3,5-trihydroxycyclohexane, 1,3,5-tris(2-hydroxyethyl)isocyanurate, bis(hydroxymethyl)tricyclo[5.2.1.02,6]decane, 4,8-bis(hydroxymethyl)tricyclo[5.2.1.02,6]decane, 5,8-bis(hydroxymethyl)tricyclo[5.2.1.0(2,6)], di-trimethylolpropane, 2,2-bis(hydroxymethyl)propane-1,3-diol (pentaerythritol), 2,2,6,6-tetrakis(hydroxymethyl)-4-oxaheptane-1,7-diol (dipentaerythritol), mannitol or sorbitol, low-molecular-weight ether alcohols, for example diethylene glycol, triethylene glycol, tetraethylene glycol, dipropylene glycol or dibutylene glycol, low-molecular-weight ester alcohols, for example neopentyl glycol hydroxypivalate, and mixtures thereof.

Polyols P very particularly preferred according to the invention are selected from the group consisting of 1,1,1-trimethylolpropane (TMP), a polyester formed from of hexane-1,6-diol, neopentyl glycol, butane-1,4-diol, adipic acid, 2,2,4-trimethylpentane-1,3-diol, 2-butyl-2-ethylpropane-1,3-diol, or a polyacrylate polyol formed from styrene, 1-decene, methyl methacrylate, acrylic acid, hydroxyethyl methacrylate, hydrophobic vinyl ester, and mixtures thereof.

In general formula (I), R in each case independently denotes at least one polyisocyanate unit and/or at least one diisocyanate unit.

The compound of the general formula (I) preferably contains according to the invention as unit R at least one polyisocyanate unit.

The at least one polyisocyanate unit R is according to the invention preferably derived from a polyisocyanate. The at least one polyisocyanate is preferably selected from the group consisting of aliphatic, cycloaliphatic, araliphatic, aromatic polyisocyanates, and mixtures thereof.

Particular preference is given to using as unit R in accordance with the invention polyisocyanates selected from the group consisting of triisocyanates such as 3,5,5-trimethyl-1-isocyanato-3-isocyanatomethylcyclohexane or preferably higher-molecular-weight oligomers having biuret, uretdione, isocyanurate, iminooxadiazinedione, allophanate, urethane- and/or carbodiimide/uretonimine structural units obtainable through reaction of di- or triisocyanates selected from the group consisting of butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′-, and 4,4′-MDI or mixtures thereof), diisocyanatomethylbenzene (tolylene 2,4- and 2,6-diisocyanate, TDI) and technical mixtures of the two isomers and also 1,3- and/or 1,4-bis(isocyanatomethyl)benzene (XDI), 3,3′-dimethylbiphenyl 4,4′-diisocyanate (TODI), 1,4-para-phenylene diisocyanate (PPDI), cyclohexyl diisocyanate (CHDI), and mixtures thereof.

The polyisocyanate used as unit R according to the invention is very particularly preferably selected from the group consisting of preferably higher-molecular-weight oligomers having biuret, uretdione, isocyanurate, iminooxadiazinedione, allophanate, urethane- and/or carbodiimide/uretonimine structural units obtainable through reaction of di- or triisocyanates selected from the group consisting of pentane 1,5-diisocyanate (pentamethylene diisocyanate, PDI), hexane 1,6-diisocyanate (hexamethylene diisocyanate, HDI), 4,4′-methylenebis(cyclohexyl isocyanate) (H12MDI), 3,5,5-trimethyl-1-isocyanato-3-isocyanatomethylcyclohexane (isophorone diisocyanate, IPDI), diisocyanatodiphenylmethane (2,2′-, 2,4′-, and 4,4′-MDI or mixtures thereof), diisocyanatomethylbenzene (tolylene 2,4- and 2,6-diisocyanate, TDI), and technical mixtures of the two isomers and mixtures thereof.

In a less preferred embodiment of the present invention, those used as unit R are derived from diisocyanates. These are selected for example from the group consisting of organic aliphatic, cycloaliphatic, araliphatic, aromatic diisocyanates and mixtures thereof.

Examples of diisocyanates used as unit R are selected from the group consisting of butane 1,4-diisocyanate, pentane 1,5-diisocyanate (pentamethylene diisocyanate, PDI), hexane 1,6-diisocyanate (hexamethylene diisocyanate, HDI), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′-, and 4,4′-MDI or mixtures thereof), diisocyanatomethylbenzene (tolylene 2,4- and 2,6-diisocyanate, TDI), and technical mixtures of the two isomers and also 1,3- and/or 1,4-bis(isocyanatomethyl)benzene (XDI), 3,3′-dimethylbiphenyl 4,4′-diisocyanate (TODI), 1,4-para-phenylene diisocyanate (PPDI), and also cyclohexyl diisocyanate (CHDI) and mixtures thereof.

In general formula (I), Q denotes at least one polysiloxane unit. The at least one polysiloxane unit Q present in the compound of general formula (I) is according to the invention preferably derived from a polysiloxane polyol, a polysiloxane polyamine or a polysiloxane polythiol, in particular a polysiloxane polyol.

It is in accordance with the invention possible in principle to use all polysiloxane polyols, polysiloxane polyamines or polysiloxane polythiols known to those skilled in the art so as to obtain corresponding polysiloxane units in the compound of the general formula (I).

In a preferred embodiment of the present invention, the polysiloxane units Q present are based on compounds of the general formula (II)

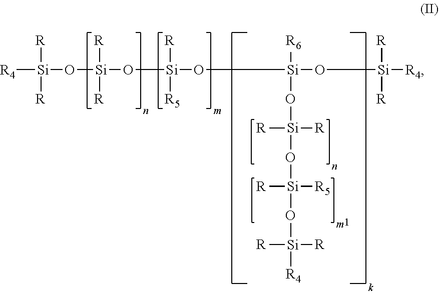

where

R, R₄, R₅, R₆, n, n¹, m, m¹, and k are defined as follows:
n and n¹ are independently 0 or greater than 0, preferably 10 to 200, more preferably 15 to 100, and (n+n¹) less than 500, preferably less than 200, more preferably less than 100,
m and m¹ are independently 0 or greater than 0, preferably 0 to 30, more preferably 0.1 to 25, and (m+m¹) less than 60, preferably less than 30, more preferably less than 25,
k 0 to 10, preferably 0 to 5, for example 0, 1, 2, 3, 4, or 5,
R at least one radical selected from the group consisting of linear, cyclic or branched, aliphatic or aromatic, saturated or unsaturated carbon radicals having 1 to 20 carbon atoms and optionally heteroatoms selected from the group consisting of O, P, S, N, in each case optionally having a functional group selected from the halogen, hydroxy, amine, mercapto, carboxy, alkoxy, epoxy, alkylalkoxysilylalkyl or alkoxysilylalkyl group, in particular methyl,
R₄, R₅, R₆ at least one radical selected from the group consisting of linear, cyclic or branched, aliphatic or aromatic, saturated or unsaturated carbon radicals having 1 to 20 carbon atoms and optionally heteroatoms selected from the group consisting of O, P, S, N, in each case optionally having a functional group selected from the halogen, hydroxy, amine, mercapto, carboxy, alkoxy, epoxy, alkylalkoxysilylalkyl or alkoxysilylalkyl group, —(CH₂)_{x″}—O—(CH₂—CH₂O—)ₓ—(CH₂—CH(R′)O—)_{y}—(SO)_{z}—R″, in which
x is 0 to 100, preferably 1 to 5,
x″ is 0 to 100, preferably 1 to 4,
y is 0 to 100, preferably 1 to 5,
z is 0 to 100, preferably 0 to 1,
R′ is an optionally substituted alkyl or aryl group having 1 to 12 carbon atoms, for example one substituted by alkyl radicals, aryl radicals or haloalkyl or haloaryl radicals, and
R″ is a hydrogen radical or an alkyl group having 1 to 4 carbon atoms, a —C(O)—R′″ group where R′″=alkyl radical, a —CH₂—O—R′ group, an alkylaryl group or a —C(O)NH—R′ group,
SO is a styrene oxide residue —CH(C₆H₅)—CH₂—O—,

in which at least two, preferably 2 to 5, more preferably 2, radicals selected from R, R₄, R₅ and/or R₆ bear at least one hydroxy, amine and/or thiol group, preferably at least one hydroxy group.

In the compounds of the general formula (II), the various monomer units of the siloxane chain and/or of the polyoxyalkylene chain can form blocks with one another or be randomly distributed.

In the context of the present inventions, all numerical indices and value ranges stated in accordance with the invention can be understood as meaning average values of the possible statistical distribution of the structures actually present and/or of mixtures thereof. It is in accordance with the invention also possible for numerical indices to be present in the form of decimal numbers (numbers separated by a decimal point), for example 1.2. In this case as the average value of a mixture comprising compounds having different numerical indices.

In a preferred embodiment, R in general formula (II) is methyl, ethyl and/or phenyl.

Further preferably, R in general formula (II) denotes R₄, R₅ and/or R₆, for example

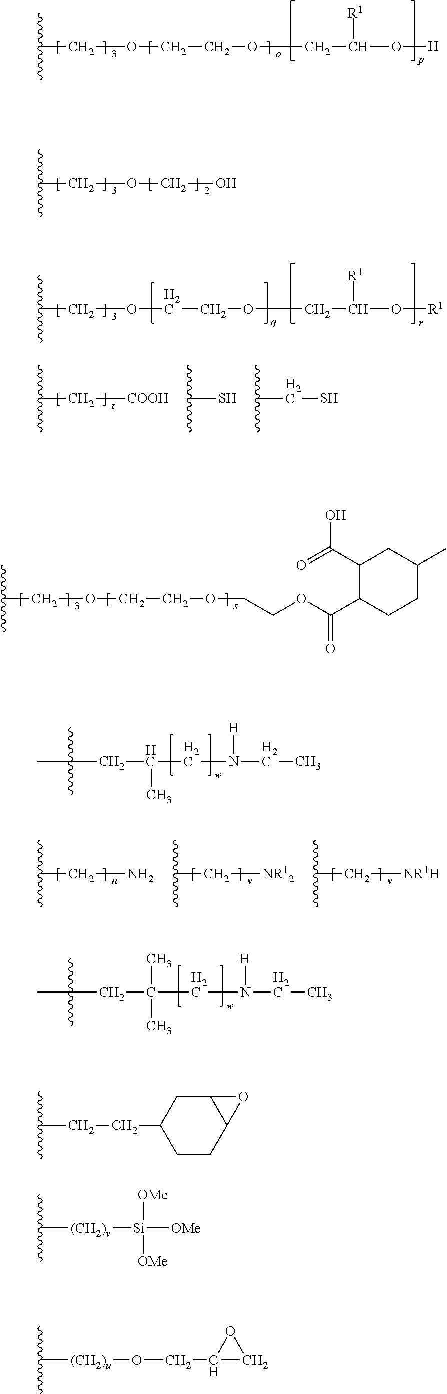

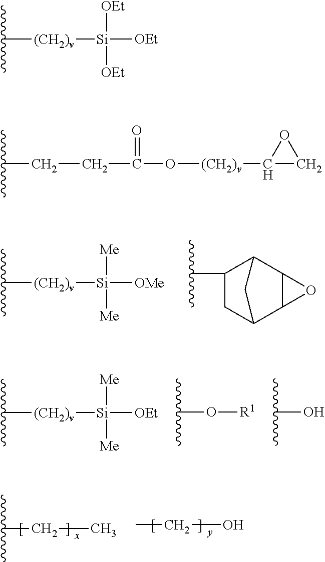

where
m=6 to 20, preferably 8 to 18,
n=2 to 18, preferably 4 to 8,
o=0 to 30, preferably 2 to 20, in particular 5 to 15,
p=0 to 30, preferably 0 to 10,
q=0 to 30, preferably 2 to 20, in particular 5 to 15,
r=0 to 30, preferably 0 to 10,
s=0 to 10, preferably 1 to 5,
t=1 to 20, preferably 1 to 10,
u=1 to 10, preferably 2 to 4,
v=1 to 10, preferably 2 to 5,
w=1 to 6, preferably 1 to 3,
x=1 to 6, preferably 2 to 4,
y=1 to 10, preferably 1 to 3.

The functionality of the polysiloxane polyols, polysiloxane polyamines or polysiloxane polythiols used with preference according to the invention is for example 2 to 6, particularly preferably 2, 3, 4, 5 or 6, very particularly 2.

The polysiloxane polyols, polysiloxane polyamines or polysiloxane polythiols used with preference according to the invention contain for example 1 to 50, particularly preferably 2 to 30, very particularly 3 to 20, repeat units. A “siloxane” is in accordance with the invention understood as meaning a group having a basic structure that contains two or more —SiO— groups.

Very particular preference is given to using as the polysiloxane polyol in accordance with the invention an α,ω-hydroxypropyl-terminated polydimethylsiloxane having an OH content of 1% to 10%, preferably 2 to 8% by weight, a molecular weight of 200 to 2000 g/mol, preferably 400 to 1000 g/mol, and a solids content of 100% by weight, so that, after reaction with the NCO groups of the diisocyanates and/or polyisocyanates of the unit M, a corresponding polysiloxane unit Q is present.

The present invention relates preferably to the polysiloxane prepolymer of the invention, wherein the at least one polysiloxane unit is present in an amount of from 0.1% to 5% by weight based on the total polysiloxane prepolymer.

In addition, the present invention relates preferably to the polysiloxane prepolymer of the invention, wherein the polysiloxane prepolymer of the invention has a number-average molecular weight Mn of <4000 g/mol, preferably of >450 g/mol and <3000 g/mol, particularly preferably of >650 g/mol and <2500 g/mol, and very particularly preferably of >800 g/mol and <2500 g/mol. The number-average molecular weight Mn is determined by gel-permeation chromatography (GPC) in tetrahydrofuran at 23° C. The procedure is in accordance with DIN 55672-1:2016-03: “Gel-permeation chromatography, part 1—Tetrahydrofuran as elution solvent” (SECurity GPC System from PSS Polymer Service, flow rate 0.6 ml/min; columns: 2×PSS SDV (100 A), 2×PSS SDV (50 A), 8×300 mm, 5 μm; RID detector (RI-Agilent 1260). Polystyrene samples of known molar mass are used for calibration. The number-average molecular weight is calculated by the software.

In general formula (I), r describes in each case the number of units R present, which in turn are selected from the abovementioned group. In general formula (I), r denotes, preferably in each case independently, a number from 1 to 30, particularly preferably 1 to 20, more preferably 1 to 5, very particularly preferably r is 1.

In general formula (I), m describes in each case the number of units M present, which in turn are selected from the abovementioned group. In general formula (I), m denotes, preferably in each case independently, a number from 1 to 30, particularly preferably 1 to 20, more preferably 1 to 5, very particularly preferably m is 1.

In general formula (I), p describes in each case the number of units P present, which in turn are selected from the abovementioned group. In general formula (I), p denotes, preferably in each case independently, a number from 1 to 30, particularly preferably 1 to 20, more preferably 1 to 5, very particularly preferably p is 1.

In general formula (I), q describes in each case the number of units Q present, which in turn are selected from the abovementioned group. In general formula (I), q denotes, preferably in each case independently, a number from 1 to 30, particularly preferably 1 to 20, more preferably 1 to 5, very particularly preferably q is 1.

In general formula (I), t describes in each case the number of units -[(M)ₘ-(P)ₚ—(R)ᵣ] present that are attached to the unit(s) Q. In general formula (I), t denotes, preferably in each case independently, a number from 2 to 5, particularly preferably 2, 3 or 4, very particularly preferably t is 2.

A monofunctional compound may according to the invention additionally also be employed as the compound containing siloxane groups, for example a poly(dimethylsiloxane) propylhydroxy copolymer, in particular heptamethyl-2-(3-hydroxypropyl)trisiloxane having a functionality of 1 and a molecular weight of 280 g/mol.

The present invention also relates to a process for preparing an NCO-terminated polysiloxane prepolymer of the invention, comprising at least the following steps:
(A) reacting at least one polysiloxane polyol, polysiloxane polyamine and/or polysiloxane polythiol with at least one diisocyanate and/or at least one polyisocyanate so as to obtain at least one NCO-terminated polysiloxane,
(B) optionally removing the excess of the at least one diisocyanate and/or at least one polyisocyanate,
(C) reacting the at least one NCO-terminated polysiloxane from step (A) or (B) with at least one polyol,
(D) reacting the product obtained in step (C) with at least one diisocyanate or at least one polyisocyanate so as to obtain the NCO-terminated polysiloxane prepolymer.

The individual steps of the process of the invention are described in detail hereinbelow.

Step (A) of the process of the invention comprises the reaction of at least one polysiloxane polyol, polysiloxane polyamine and/or polysiloxane polythiol, preferably at least one polysiloxane polyol, with at least one diisocyanate and/or at least one polyisocyanate, preferably at least one diisocyanate, so as to obtain at least one NCO-terminated polysiloxane.

Step (A) of the process of the invention can generally be carried out by any process known to those skilled in the art. Preferably, step (A) of the process of the invention can be carried out in the devices known to those skilled in the art, for example stirred-tank reactors having inlets and outlets for reactants and products. Optionally, step (A) of the process of the invention may be carried out with exclusion of water and air, for example in a dry atmosphere of nitrogen or a noble gas, for example helium or argon.

Step (A) of the process of the invention can be carried out for example by mixing the substrates, in particular the at least one diisocyanate and/or the at least one polyisocyanate and the at least one polysiloxane polyol, polysiloxane polyamine and/or polysiloxane polythiol, with one another and reacting them together.

In a preferred embodiment, step (A) of the process of the invention is carried out by initially charging the at least one diisocyanate and/or the at least one polyisocyanate. The at least one diisocyanate and/or the at least one polyisocyanate may according to the invention be initially charged in a solvent or without solvent. Suitable solvents for this reaction step are preferably ones that do not take part in the reaction itself, for example ethyl acetate, butyl acetate, methoxypropyl acetate, solvent naphtha (Solvesso 100) and/or methyl ethyl ketone. Step (A) of the process of the invention is preferably carried out in the absence of a solvent. The initially charged at least one diisocyanate and/or at least one polyisocyanate is according to the invention preferably heated to a temperature above room temperature, for example 60 to 120° C., preferably 80 to 110° C.

More preferably, the at least one polysiloxane polyol, polysiloxane polyamine and/or polysiloxane polythiol is added to the initially charged at least one diisocyanate and/or at least one polyisocyanate.

The ratio of NCO groups present in the reaction mixture to NCO-reactive groups, i.e. OH, SH and/or NH groups, is in step (A) of the process of the invention generally 1 to 50, preferably 2 to 30, more preferably 2 to 20.

The reaction mixture obtained is generally stirred until reaction is complete. The reaction mixture is preferably stirred for 1 to 8 h, preferably 2 to 6 h.

The reaction according to step (A) of the process of the invention is preferably carried out at a temperature of 60 to 120° C., more preferably 80 to 110° C.

After step (A) of the process of the invention, a reaction mixture is obtained that comprises the reaction product of the at least one polysiloxane polyol, polysiloxane polyamine and/or polysiloxane polythiol with at least one diisocyanate or at least one polyisocyanate, i.e. at least one NCO-terminated polysiloxane.

The reaction mixture obtained in step (A) may according to the invention either be used directly in step (C) of the process of the invention. This is preferably done when the ratio of NCO groups to NCO-reactive groups in the reaction mixture had been set such that the NCO-terminated polysiloxane is obtained, but no excess of at least one diisocyanate and/or at least one polyisocyanate was present, i.e. there was no excess of at least one diisocyanate and/or at least one polyisocyanate present in the reaction mixture obtained after step (A).

In a preferred embodiment of the present invention, the reaction mixture obtained in step (A) of the process of the invention is transferred, particularly preferably without further intermediate steps, to step (B) of the process of the invention.

The optional step (B) of the process of the invention comprises the removal of the excess of at least one diisocyanate or at least one polyisocyanate.

Step (B) is preferably performed. By removing the excess of at least one diisocyanate or at least one polyisocyanate in step (B) of the process of the invention, the NCO-terminated polysiloxane polyol is obtained that is not contaminated with at least one diisocyanate and/or at least one polyisocyanate. Performing step (B) of the invention therefore makes it possible to obtain the desired target compound of the invention, the NCO-terminated polysiloxane prepolymer, in high purity, uniformity and—compared to alternative production processes—with an increased molecular weight.

The content in the reaction mixture after step (B) of at least one diisocyanate or at least one polyisocyanate, preferably at least one diisocyanate, is according to the invention preferably not more than 5% by weight, preferably 1% to 0.01% by weight.

Step (B) of the process of the invention may in principle be carried out by any process known to those skilled in the art. The present invention preferably relates to the process of the invention wherein step (B) is carried out by thin-film evaporation, phase separation, precipitation or combinations thereof.

Step (B) of the process of the invention is preferably carried out by thin-film evaporation. More preferably, the thin-film evaporation is carried out at a temperature of 50 to 200° C., preferably 80 to 120° C. The thin-film evaporation is in addition carried out at a pressure of preferably 0.001 to 500 mbar(a), more preferably 0.01 to 200 mbar(a).

Step (B) of the process of the invention may be carried out in all devices known to those skilled in the art, more particularly in a thin-film evaporator or apparatuses suitable for phase separation or precipitation.

The NCO-terminated polysiloxane polyol obtained after step (A) or (B), preferably after step (B), has an NCO content of generally 1% to 20% by weight, preferably 4% to 18% by weight.

The NCO-terminated polysiloxane polyol obtained after step (A) or (B), preferably after step (B), has a concentration of generally 100% to 50% by weight, preferably 100% to 75% by weight. This means that the desired product is preferably obtained without impurities and solvents.

The NCO-terminated polysiloxane polyol obtained after step (A) or (B), preferably after step (B), has a viscosity of generally 50 to 4000 mPa·s, preferably 100 to 2500 mPa·s, more preferably 100 to 1000 mPa·s.

Step (C) of the process of the invention comprises the reaction of the at least one NCO-terminated polysiloxane from step (A) or (B) with at least one polyol.

Step (C) of the process of the invention can generally be carried out by any method known to those skilled in the art. The NCO-terminated polysiloxane from step (A) or (B) is according to the invention preferably mixed and reacted with the at least one polyol. Polyols that are suitable and preferred according to the invention have already been mentioned hereinabove.

The molar ratio of the NCO groups present in the reaction mixture according to step (C) of the process of the invention to the OH, NH and/or SH groups present in the at least one polyol used is preferably 0.001 to 0.9, more preferably 0.01 to 0.8.

Step (C) of the process of the invention may be carried out in the presence of a solvent or in the absence of a solvent. In a preferred embodiment, step (C) of the process of the invention is carried out in the presence of a solvent. The solvent used in step (C) of the process of the invention is preferably selected from the group consisting of esters, for example 1-methoxy-2-propyl acetate (MPA), butyl acetate (BA), dibasic esters, ketones, for example methyl ethyl ketone, ethers, for example diethyl ether, and mixtures thereof.

In the reaction mixture according to step (C) of the process of the invention, the components are present overall in a concentration of 20% to 80% by weight, preferably 30% to 70% by weight, in each case the solids content based on the total solution.

The reaction according to step (C) of the process of the invention may be carried out in the presence of at least one catalyst. Suitable catalysts are known per se to those skilled in the art and are selected for example from the group of tin organyls, dibutyltin laurate being particularly suitable. If a catalyst is used in step (C) of the process of the invention, it is preferably present in a concentration of 0.01% to 0.1% by weight based on the reaction mixture.

Step (C) of the process of the invention may be carried out in the devices known per se to those skilled in the art, for example stirred-tank reactors having appropriate inlets and outlets. In addition, step (C) of the process of the invention may preferably be carried out in an inert atmosphere, for example in an atmosphere of nitrogen or a noble gas, for example helium or argon.

Step (C) of the process of the invention is preferably carried out at a temperature of 20 to 100° C., preferably 40 to 80° C. As a general rule, step (C) of the process of the invention is carried out at atmospheric pressure or by using an inert gas at a pressure slightly higher than atmospheric pressure.

Step (C) of the process of the invention is generally continued until all of the NCO groups present have reacted, i.e. have reacted with an OH or SH group. Preferably, step (C) of the process of the invention is continued until the content of NCO groups present in the reaction mixture is less than 0.5% by weight, more preferably less than 0.2% by weight, in each case based on the entire reaction mixture. Very particularly preferably, there are no longer any NCO groups present in the reaction mixture, i.e. the NCO group content is below the analytical detection limit known to those skilled in the art.

In a preferred embodiment of the process of the invention, the reaction mixture obtained at the end of step (C) can be transferred directly to step (D) of the process of the invention. The reaction mixture may optionally be worked up after step (C) and before step (D).

Step (D) of the process of the invention comprises reacting the product obtained in step (C) with at least one polyisocyanate and/or at least one diisocyanate, preferably with at least one polyisocyanate, so as to obtain the NCO-terminated polysiloxane prepolymer,

Step (D) of the process of the invention can generally be carried out by any method known to those skilled in the art. In a preferred embodiment of the present invention, the at least one polyisocyanate and/or the at least one diisocyanate, preferably the at least one polyisocyanate, is added to the reaction mixture obtained from step (C).

The molar ratio of the OH or SH groups present in the reaction mixture employed in step (D) to the NCO groups added in step (D) is according to the invention preferably 1.1 to 20, more preferably 2 to 12.

Step (D) of the process of the invention is preferably carried out in the presence of a solvent. In a preferred embodiment of the process of the invention, the reaction mixture used in step (D) already contains solvents from step (C). In a further preferred embodiment of the present invention, solvent is added in step (D) of the process of the invention. In a preferred embodiment, sufficient solvent is added in step (D) that the concentration of the dissolved components in the reaction mixture is 20% to 80% by weight, preferably 30% to 70% by weight, in each case based on the entire reaction mixture. Suitable solvents for step (D) have already been mentioned with regard to step (C).

Step (D) of the process of the invention may be carried out in the devices known to those skilled in the art, for example stirred-tank reactors having appropriate inlets and outlets. In addition, step (D) of the process of the invention may preferably be carried out in an inert atmosphere, for example in an atmosphere of nitrogen or a noble gas, for example helium or argon.

Step (D) of the process of the invention is preferably carried out at a temperature of 20 to 100° C., preferably 40 to 80° C. As a general rule, step (D) of the process of the invention is carried out at atmospheric pressure or by using an inert gas at a pressure slightly higher than atmospheric pressure.

After step (D) of the process of the invention, the desired NCO-terminated polysiloxane prepolymer of the invention, more particularly the prepolymer of the general formula (I), is obtained. Step (D) may optionally be followed by the performance of workup steps, for example removal of the solvent present, such as ethyl acetate, methoxypropyl acetate, butyl acetate, solvent naphtha (Solvesso 100) or mixtures thereof.

The NCO-terminated polysiloxane prepolymer obtained after step (D) has an NCO content of generally 0.1% to 17% by weight, preferably 2% to 14% by weight.

The NCO-terminated polysiloxane prepolymer obtained after step (D) has a solids content of generally 20% to 80% by weight, preferably 30% to 70% by weight.

The NCO-terminated polysiloxane prepolymer obtained after step (D) has a Hazen color index of generally 0 to 300, preferably 10 to 150.

The present invention also provides an NCO-terminated polysiloxane prepolymer obtainable or produced by the process of the invention. Particular features of the NCO-terminated polysiloxane prepolymer of the invention are, firstly, that the coatings obtainable therefrom have significantly better residual gloss and reflow than comparable systems without the NCO-terminated polysiloxane prepolymer of the invention and, secondly, that they can, as surface-active substances, allow flow additives to be used in smaller amounts or be omitted altogether. The measurement of residual gloss and reflow is preferably carried out as stated in the Examples section, the reduction in leveling additives being observed preferably through visual evaluation of the coating to see whether or not an “orange peel” has formed.

The present invention further relates to a formulation comprising at least one NCO-terminated polysiloxane prepolymer of the invention, preferably in an amount of from 5% to 70% by weight based on the entire formulation. More particularly, the formulation of the invention is a paint formulation.

Aside from the NCO-terminated polysiloxane prepolymer of the invention, corresponding formulations are known per se to those skilled in the art.

The paint formulation of the invention may preferably be in the form of a 2-component formulation known per se to those skilled in the art.

A 2-component formulation of the invention preferably comprises in the first component at least one polyhydroxy compound and optionally additives (component A) and in the second component at least one NCO-terminated polysiloxane prepolymer of the invention, at least one polyisocyanate, and optionally additives (component B).

In a preferred embodiment of the invention, the paint formulation of the invention, more particularly the 2-component formulation of the invention, is a formulation for a clearcoat and/or topcoat layer.

A basecoat may be present beneath the clearcoat and/or topcoat layer of the invention. The composition, requirements and processing of formulations for basecoats are known per se to those skilled in the art and are described for example in the specifications of automobile companies or for example in the article “Eine Frage der Einstellung” [A question of attitude], published in “Farbe und Lack July 2003” [Color and paint July 2003] (Vincentz-Verlag), pages 1-3, also in U. Poth, “Automotive Coatings Formulation”, Vincentz-Verlag 2008, ISBN 9783866309043, pages 137-163 and 213-215, or in U. Kuttler, “Principles of Automotive OEM Coatings”, Allnex Belgium S.A.

In component A of the 2-component formulation of the invention, at least one polyhydroxy compound is preferably present. The polyhydroxy compound is by preference selected from the group consisting of polyester polyols, polyurethane polyols, polysiloxane polyols, polycarbonate polyols, polyacrylate polyols, and mixtures thereof, preferably selected from the group consisting of polyester polyols, polyacrylate polyols, polyurethane polyols, and mixtures thereof. Corresponding polyhydroxy compounds are known per se to those skilled in the art and are described for example hereinabove in this document.

The polycarbonate polyols that may be used are obtainable by reacting carbonic acid derivatives, for example diphenyl carbonate, dimethyl carbonate or phosgene, with diols. Examples of suitable diols of this kind include ethylene glycol, propane-1,2- and 1,3-diol, butane-1,3-diol and -1,4-diol, hexane-1,6-diol, 2-ethylhexane-1,3-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, tetrabromobisphenol A, but also lactone-modified diols. Preferably, the diol component contains 40% to 100% by weight of hexane-1,6-diol and/or hexanediol derivatives, preferably those having not only terminal OH groups but also ether or ester groups, for example products obtained by reacting 1 mol of hexanediol with at least 1 mol, preferably 1 to 2 mol, of ε-caprolactone, or by etherification of hexanediol with itself to give di- or trihexylene glycol. It is also possible to use polyether polycarbonate polyols.

Preference is given to polycarbonate polyols based on dimethyl carbonate and hexanediol and/or butanediol and/or ε-caprolactone. Very particular preference is given to polycarbonate polyols based on dimethyl carbonate and hexanediol and/or ε-caprolactone.

Suitable polyols also include for example the known polyacetal polyols obtainable by the reaction with formaldehyde of simple glycols, for example diethylene glycol, triethylene glycol, 4,4′-di((2-hydroxyethoxy)phenyl)dimethylmethane (adduct of 2 mol of ethylene oxide to bisphenol A) or hexanediol, or else polyacetals prepared by polycondensation of cyclic acetals, for example trioxane.

Further suitable polyols also include for example those described in EP-A 0 689 556 and EP-A 0 937 110, for example specific polyols obtainable by reacting epoxidized fatty acid esters with aliphatic or aromatic polyols by epoxide ring opening.

Polybutadienes containing hydroxyl groups can likewise serve as polyols.

The polymeric polyols may be used individually or in the form of any desired mixtures with one another. They may be either solvent-free or dissolved in customary solvents.

In addition, additives may be present in component (A) of the 2-component formulation of the invention. Such additives are known per se to those skilled in the art.

The optionally present additive is according to the invention selected from the group consisting of catalysts, solvents, light stabilizers such as UV absorbers and sterically hindered amines (HALS), stabilizers, for example UV stabilizers, fillers, antisettling agents, defoaming agents, anticratering agents, wetting agents, leveling agents, film-forming auxiliaries, reactive diluents, substances for rheology control, slip additives, components that prevent soiling and/or improve the cleanability of the cured paints, matting agents, antioxidants, pigments, and mixtures thereof. Preference is given here to UV stabilizers, antioxidants, leveling agents, fillers and/or pigments.

Catalysts suitable according to the invention are those suitable for catalyzing the reaction of component A with component B. Such catalysts are known to those skilled in the art. Suitable catalysts are in particular tin catalysts, bismuth catalysts, zinc catalysts, zirconium catalysts, and amine bases. Especially suitable are for example zinc compounds, for example zinc(II) stearate, zinc(II) n-octanoate, zinc(II) 2-ethyl-1-hexanoate, zinc(II) naphthenate, zinc chloride, zinc 2-ethylcaproate or zinc(II) acetylacetonate, tin compounds, for example tin(II) n-octanoate, tin(II) 2-ethyl-1-hexanoate, tin(II) laurate, dibutyltin oxide, dibutyltin dichloride, dibutyltin diacetate, tin(II) ethylcaproate, dibutyltin(IV) dilaurate, dibutyltin dimaleate or dioctyltin diacetate, zirconium compounds, for example zirconium(IV) 2-ethyl-1-hexanoate, zirconium(IV) isopropoxide, zirconium(IV) n-butoxide, zirconium(IV) 2-ethylhexanoate, zirconyl octanoate, zirconium(IV) neodecanoate, zirconium(IV) naphthenate or zirconium(IV) acetylacetonate, bismuth(III) 2-ethylhexanoate, and bismuth(III) octoate.

The catalyst is preferably used in amounts of 0.001% to 0.5% by weight, more preferably in amounts of 0.01% to 0.3% by weight, in each case based on the total weight of compound A in the first component.

Component A may further preferably comprise at least one solvent. In general, all solvents known to those skilled in the art in this field are suitable here. Especially suitable are aromatic and aliphatic solvents, preferably selected from the group consisting of butyl acetate, 1-methoxy-2-propyl acetate, 3-methoxy-1-butyl acetate, ethyl acetate, dibasic esters, propylene n-butyl ether, methyl ethyl ketone, toluene, xylene, solvent naphtha (hydrocarbon mixture), and also mixtures thereof. The solvent is preferably present in a content of 30% to 90% by weight, more preferably 45% to 70% by weight, based on the total weight of component A.

UV stabilizers suitable according to the invention may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or 2,2′-dihydroxy-4-dodecyloxybenzophenone; benzotriazole derivatives, for example 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides, for example 2-ethyl-2′-ethoxy- or 4-methyl-4′-methoxyoxalanilide; salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, for example dimethyl 4-methoxybenzylidenemalonate, diethyl 4-methoxybenzylidenemalonate, dimethyl 4-butoxybenzylidenemalonate, DL-alpha-tocopherol, tocopherol, cinnamic acid derivatives, cyanoacrylates, and mixtures thereof. These preferred UV stabilizers may be used either individually or in any desired combinations with one another. Particularly preferred UV stabilizers are available under the trade names Tinuvin® 292 and Tinuvin® 1130 from BASF SE.

Sterically hindered amines (often also referred to as HALS or HAS compounds=hindered amine (light) stabilizers) can serve as suitable radical scavengers. These are selected from the group consisting of 2,2,6,6-tetramethylpiperidine, 2,6-di-tert-butylpiperidine or derivatives thereof, for example bis(2,2,6,6-tetramethyl-4-piperidyl) sebacate, and mixtures thereof. These are available, for example, as Tinuvin® and Chimassorb® brands from BASF SE. Examples of N-alkylated radical scavengers include bis(1,2,2,6,6-pentamethyl-4-piperidinyl) [[3,5-bis(1,1-dimethylethyl)-4-hydroxyphenyl]methyl]butylmalonate (e.g. Tinuvin® 144 from BASF); a mixture of bis(1,2,2,6,6-pentamethyl-4-piperidinyl) sebacate and methyl (1,2,2,6,6-pentamethyl-4-piperidinyl) sebacate (e.g. Tinuvin® 292 from BASF SE); or which are N—(O-alkylated), such as bis(2,2,6,6-tetramethyl-1-(octyloxy)-4-piperidinyl) decanedioate, reaction products with 1,1-dimethylethyl hydroperoxide and octane (e.g. Tinuvin® 123 from BASF SE), and especially the HALS triazine, reaction products of 2-aminoethanol with cyclohexane and peroxidized N-butyl-2,2,6,6-tetramethyl-4-piperidinamine-2,4,6-trichloro-1,3,5-triazine reaction product (e.g. Tinuvin® 152 from BASF SE).

Optionally, one or more of the UV stabilizers of component A mentioned by way of example are used preferably in amounts of 0.001% to 3.0% by weight, more preferably 0.01% to 2% by weight, based on the total weight of compound A.

Antioxidants suitable according to the invention are preferably sterically hindered phenols, which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol), and 2,2′-thiodiethyl bis[3-(3,5-di-tert-butyl-4-hydroxyphenyl)propionate]. These may be used either individually or in any desired combinations with one another as required. Antioxidants are preferably used in amounts of 0.001% to 3.0% by weight, more preferably 0.02% to 2.0% by weight, in each case calculated as the total amount of antioxidants used, based on the total weight of compound A.

To improve substrate wetting, suitable leveling agents may optionally be present, for example organically modified siloxanes, such as polyether-modified siloxanes, polyacrylates and/or fluorosurfactants. These leveling agents are used by preference in amounts of from 0.01% by weight to 3% by weight, preferably from 0.01% by weight to 2% by weight, more preferably from 0.05% to 1.5% by weight, calculated as the total amount of leveling agents used based on the total weight of compound A. Preferred leveling agents are commercially available under the trade names BYK 141 and BYK 311 from Altana.

The polyisocyanates present in component B of the 2-component formulation of the invention are selected for example from the group for the synthesis of the polysiloxane prepolymer of the invention mentioned hereinabove. Preferred polyisocyanates include all higher-molecular-weight oligomers having biuret, uretdione, isocyanurate, iminooxadiazinedione, allophanate, urethane and/or carbodiimide/uretonimine structural units obtainable through reaction of di- or triisocyanates selected from the group consisting of PDI, HDI, HDI, H12MDI, IPDI, and mixtures thereof. These polyisocyanates are generally present in an amount of from 5% to 50% by weight, preferably 5% to 25% by weight, in each case based on the entire formulation consisting of component A and component B.

In addition, component B of the 2-component formulation of the invention comprises the NCO-terminated polysiloxane prepolymer of general formula (I) of the invention. This is present for example in an amount of generally 50% to 95% by weight, preferably 75% to 95% by weight, in each case based on component B.

There are preferably no further additives in component B besides the compounds mentioned.

The 2-component formulation of the invention may according to the invention also be an aqueous formulation. In this embodiment, the abovementioned at least one solvent is replaced by water in component A and/or in component B of the 2-component formulation of the invention.

In addition to the NCO-terminated siloxane prepolymer of the invention, the polyisocyanate component A) may optionally also contain polyisocyanates having aliphatically, cycloaliphatically, araliphatically and/or aromatically attached isocyanate groups, which optionally also contain siloxane chains. These further polyisocyanates are in particular the known paint isocyanates containing uretdione, isocyanurate, iminooxadiazinedione, urethane, allophanate, biuret and/or oxadiazinetrione structure, as described for example in Laas et al., J. Prakt. Chem. 336, 1994, 185-200, in DE-A 1 670 666, DE-A 3 700 209, DE-A 3 900 053, EP-A 0 330 966, EP-A 0 336 205, EP-A 0 339 396, and EP-A 0 798 299. Preference is given to using for this purpose the compounds described as unit R hereinabove.

Particularly preferred further polyisocyanates in polyisocyanate component A) are those of the stated type having exclusively aliphatically and/or cycloaliphatically attached isocyanate groups, in particular those based on PDI, HDI and/or IPDI.

These further polyisocyanates are in the coating compositions of the invention optionally used in amounts of up to 70% by weight, preferably up to 60% by weight, more preferably up to 50% by weight, based on the total amount of polyisocyanate component A), consisting of at least one NCO-terminated siloxane prepolymer and optionally further polyisocyanates.

The formulations of the invention, in particular paint formulations, may comprise as a binder component any desired aqueous polymer dispersions B), which preferably bear groups that are reactive toward isocyanate groups, particularly preferably hydroxyl groups and/or amino groups.

All polymer dispersions customary in aqueous 2C PUR paint technology are suitable as aqueous polymer dispersions B). These are for example the customary aqueous or water-dispersible polyacrylate resins, polyester resins, polyurethane resins, polyurea resins, polycarbonate resins or polyether resins, of the kind described for example in EP-A 0 358 979, EP-A 0 469 389, EP-A 0 496 205, EP-A 0 557 844, EP-A 0 583 728, WO 94/03511, WO 94/20559, WO 94/28043 or WO 95/02005. It is also possible to use any desired hybrid dispersions or any desired mixtures of different polymer dispersions.

Examples of suitable hydroxy-functional polyacrylate dispersions B1) are the known so-called secondary polyacrylate dispersions, which can be produced in a manner known per se by copolymerization of olefinically unsaturated monomers having hydroxyl groups groups with hydroxyl-free olefinic monomers in organic solvents, neutralization of any ionic groups incorporated, and dispersion in water.

Examples of suitable monomers for producing the secondary polyacrylate dispersions B1) are for example vinyl and vinylidene monomers such as, for example, styrene, α-methylstyrene, o- and/or p-chlorostyrene, o-, m- or p-methylstyrene, p-tert-butylstyrene, acrylic acid, acrylonitrile, methacrylonitrile, acrylic and methacrylic esters of alcohols having up to 18 carbon atoms, such as methyl acrylate, ethyl acrylate, n-propyl acrylate, isopropyl acrylate, n-butyl acrylate, isobutyl acrylate, tert-butyl acrylate, amyl acrylate, hexyl acrylate, 2-ethylhexyl acrylate, isooctyl acrylate, 3,3,5-trimethylhexyl acrylate, stearyl acrylate, lauryl acrylate, cyclopentyl acrylate, cyclohexyl acrylate, 4-tert-butylcyclohexyl acrylate, norbornyl acrylate, isobornyl acrylate, methyl methacrylate, ethyl methacrylate, n-propyl methacrylate, isopropyl methacrylate, butyl methacrylate, isobutyl methacrylate, tert-butyl methacrylate, amyl methacrylate, hexyl methacrylate, 2-ethylhexyl methacrylate, isooctyl methacrylate, 3,3,5-trimethylhexyl methacrylate, stearyl methacrylate, lauryl methacrylate, cyclopentyl methacrylate, cyclohexyl methacrylate, 4-tert-butylcyclohexyl methacrylate, norbornyl methacrylate or isobornyl methacrylate, diesters of fumaric acid, itaconic acid or maleic acid alcohols having 4 to 8 carbon atoms, acrylamide, methacrylamide, vinyl esters of alkanemonocarboxylic acids having 2 to 5 carbon atoms, such as vinyl acetate or vinyl propionate, carboxy-functional radically polymerized monomers, such as acrylic acid, methacrylic acid, 1-carboxyethyl acrylate, crotonic acid, fumaric acid, maleic acid (anhydride), itaconic acid or monoalkyl esters of dibasic acids and/or anhydrides, such as monoalkyl maleates, hydroxyalkyl esters of acrylic acid and methacrylic acid having 2 to 6 carbon atoms in the hydroxyalkyl radicals, such as 2-hydroxyethyl, 2-hydroxypropyl, 3-hydroxypropyl, 3-hydroxybutyl, 4-hydroxybutyl, trimethylolpropane monoacrylate or monomethacrylate, pentaerythritol monoacrylate or monomethacrylate, hydroxyl monomers containing alkylene oxide units, such as products of the addition of ethylene oxide, propylene oxide or butylene oxide to acrylic acid or methacrylic acid, and any desired mixtures of such monomers mentioned by way of example.

Likewise suitable olefinically unsaturated monomers for producing the secondary polyacrylate dispersions B1) are vinyl monomers containing alkylene oxide units, such as condensation products of acrylic acid or methacrylic acid with oligoalkylene oxide monoalkyl ethers, and also monomers having further functional groups such as epoxy groups, alkoxysilyl groups, urea groups, urethane groups, amide groups or nitrile groups, and also (meth)acrylate monomers and/or vinyl monomers having a functionality of two or more, for example hexanediol di(meth)acrylate, which can additionally be used in small amounts of, for example, up to 3% by weight based on the sum of the monomers.

Preferred olefinically unsaturated monomers for producing the secondary polyacrylate dispersions B1) are methyl methacrylate, styrene, acrylic acid, methacrylic acid, butyl acrylate, butyl methacrylate, ethyl acrylate, tert-butyl acrylate, 2-ethylhexyl acrylate, 2-ethylhexyl methacrylate, hydroxyethyl methacrylate, hydroxypropyl methacrylate, hydroxyethyl acrylate, hydroxypropyl acrylate, hydroxybutyl acrylate or hydroxybutyl methacrylate.

In the secondary polyacrylate dispersions B1) the amount of carboxy-functional monomers is between 0.8% and 5% by weight, in particular between 1.2% and 4% by weight, and the amount of hydroxy-functional monomers is between 1% and 45% by weight, preferably between 6% and 30% by weight.

The secondary polyacrylate dispersions B1) suitable for the formulations of the invention are produced from the olefinically unsaturated monomers in the presence of polymerization initiators known per se. Examples of suitable initiators are peroxy compounds such as diacyl peroxides, alkyl peresters, dialkyl peroxides, peroxydicarbonates, inorganic peroxides or else azo compounds.

Suitable in principle are any organic solvents for producing the secondary polyacrylate dispersions B1). These solvents may be used in any desired amounts, but preferably in amounts of less than 20% by weight based on the sum of the monomers. Preference is given to solvent mixtures of at least one hydrophobic solvent, such as solvent naphtha, toluene, xylene, crystal oil, and at least one hydrophilic solvent such as butyl glycol, butyl diglycol, diethylene glycol, propylene glycol monomethyl ether or dipropylene glycol monomethyl ether.

The potentially ionic groups, in particular carboxyl groups, that are incorporated into the copolymer are customarily neutralized using suitable tertiary amines. Examples of suitable neutralizing amines are tertiary monoamines such as trimethylamine, triethylamine, tripropylamine, tributylamine, ethyldiisopropylamine, dimethylcyclohexylamine, N-methylmorpholine, N-ethylmorpholine, N-methylpiperidine, N-ethylpiperidine, tertiary diamines such as 1,3-bis(dimethylamino)propane 1,4-bis(dimethylamino)butane or N,N′-dimethylpiperazine or also tertiary amines bearing groups reactive toward isocyanates, for example alkanolamines such as dimethylethanolamine, methyldiethanolamine, 2-aminomethyl-2-methylpropanol or for example triethanolamine.

The secondary polyacrylate dispersions B1) may be produced by any desired processes known from the prior art, for example in a feed process, batch process or in cascade processes.

After the copolymer solution has been dispersed in water, the solvent used may be proportionally or completely removed by distillation.

The pH of the secondary polyacrylate dispersions B1) suitable for the coating compositions of the invention is preferably from 5 to 11, more preferably from 6 to 10.

The solids contents of the secondary polyacrylate dispersions B1) are preferably from 20% to 60% by weight, more preferably from 35% to 55% by weight. The average particle sizes are generally from 20 to 400 nm.

For the production of the secondary polyacrylate dispersions, it is possible to use so-called reactive diluents either in place of solvents or together with them. Suitable reactive diluents are for example polyethers having a functionality of two or three that are liquid at room temperature, low-viscosity polyesters such as reaction products of 1 mol of a dicarboxylic acid, such as dimer fatty acids or adipic acid, with 2 mol of a diol or triol or with 2 mol of the glycidyl ester of Versatic acid. Examples of further suitable reactive diluents are reaction products of ε-caprolactone with low-molecular-weight alcohols and hydroxy-functional oils such as castor oil.

Suitable aqueous polymer dispersions B) for the coating compositions of the invention are, for example, also so-called hydroxy-functional primary polyacrylate dispersions B2), which can be produced in the usual manner by copolymerizing olefinically unsaturated monomers having hydroxyl groups with hydroxyl-free olefinic monomers directly in an aqueous emulsion in the presence of suitable surface-active substances.

Suitable primary polyacrylate dispersions B2) and the production thereof are described for example in R O. Athey Jr., Emulsion Polymer Technology, Dekker, New York, 1991.

Monomers suitable for producing such primary polyacrylate dispersions B2) include in principle the monomers already mentioned above in connection with the production of the secondary polyacrylate dispersions B1.

In the emulsion polymerization, the polymerization initiators are generally either introduced in the initial charge and/or added in parallel, optionally with additional initiator added before and/or after. Examples of suitable initiators are redox systems, peroxides, persulfates and/or azo compounds, such as dibenzoyl peroxide, dicumene peroxide, cumene hydroperoxide, potassium peroxodisulfate, ammonium peroxodisulfate, azobisisobutyronitrile or di-tert-butyl peroxide.

Likewise suitable as aqueous polymer dispersions B) for the coating composition of the invention are the hybrid forms of polyacrylate dispersions that are known per se, such as polyester-polyacrylate dispersions B3). These dispersions contain both polyacrylate segments and polyester segments and are, for example, by free-radical (co)polymerization of monomers of the type mentioned above in connection with the production of secondary polyacrylate dispersions B1) in the presence of a polyester component, a reaction that can be carried out as a bulk polymerization or preferably in organic solution. Suitable polyester components are described hereinbelow as possible synthesis components for producing the polyurethane dispersions B4).

Polyester-polyacrylate dispersions B3) suitable as aqueous polymer dispersions B) preferably have a polyester content of 10% to 75% by weight, more preferably 20% to 60% by weight, based on the total solids content of the dispersion.

Polyurethane dispersions B4) are also suitable as aqueous polymer dispersions B) for the coating compositions of the invention. These dispersions are the generally self-emulsifying polyurethanes or polyurethane-polyureas known per se, in aqueous form.

Self-emulsifying polyurethanes contain ionic and/or nonionic hydrophilic groups in the polymer chain, it being possible for these groups to be incorporated into the polymer chain either directly or else pendently or terminally.

Suitable polyurethane dispersions B4) may be obtained by methods known to those skilled in the art by preparing a polyurethane or a polyurethane prepolymer in the melt or in organic solution and then dispersing water therein, it being possible optionally for a chain-extension reaction to increase the molecular weight to be carried out in organic solution in parallel with the dispersing step or after the dispersing step.

For the production of suitable polyurethane dispersions B4), hydrophilic groups may be incorporated into the polyurethane using various compounds reactive toward isocyanate groups that are potentially ionic and/or nonionic, for example by incorporating hydroxycarboxylic acids such as dimethylolacetic acid, 2,2-dimethylolpropionic acid, 2,2-dimethylbutyric acid, 2,2-dimethylolpentanoic acid, dihydroxysuccinic acid, hydroxypivalic acid or mixtures of such acids, aminocarboxylic acids, such as the Michael adducts of isophoronediamine or ethylenediamine with acrylic acid, aminosulfonic acids, such as aminoethylethanesulfonic acid, hydroxy- or amino-functional phosphonic acids and/or mono-, di- or trifunctional polyethylene oxide units in a molecular weight range of 350 to 2500 g/mol; the use of mixtures of such compounds is also possible.

Particularly suitable hydrophilic units are dimethylolpropionic acid, dimethylolbutyric acid, mono- or dihydroxy-functional polyethylene oxide units in the molecular weight range stated above, and also hydroxy-functional or amino-functional sulfonic acids and/or sulfonates.

Preferably serving as neutralizing agents for these hydrophilic units are tertiary amines and/or tertiary amino alcohols, as described as neutralizing amines for suitable secondary polyacrylate dispersions B1) hereinabove.

Suitable polyurethane dispersions B4) are produced using any desired aliphatic, cycloaliphatic, araliphatic and/or aromatic di- and/or polyisocyanates, such as those already mentioned above as the starting compound by way of example.

Preference is given to using isophorone diisocyanate, 4,4′-diisocyanatodicyclohexylmethane and/or hexamethylene diisocyanate.

Further synthesis components for producing suitable polyurethane dispersions B4) are polyester polyols, polyesteramide polyols, polyacetal polyols, polyether polyols, polysiloxane polyols and/or polycarbonate polyols in a molecular weight range of 500 to 18 000 g/mol and having a functionality of 1 to 5, preferably from 2 to 2.5.

Suitable polyester polyols for producing the polyurethane dispersions B4) are for example those having an average functionality of 1.5 to 5, as can be produced in a known manner by reacting aliphatic compounds cycloaliphatic or aromatic dicarboxylic acids and/or polycarboxylic acids and/or anhydrides thereof, such as succinic acid, glutaric acid, adipic acid, sebacic acid, pimelic acid, subic acid, azelaic acid, nonanedicarboxylic acid, decanedicarboxylic acid, phthalic acid, isophthalic acid, hexahydrophthalic acid, trimellitic acid, phthalic anhydride, tetrahydrophthalic acid, maleic acid, maleic anhydride, fumaric acid, dimer and trimer fatty acids, dimethyl terephthalate, and bisglycol terephthalate, with polyhydric alcohols, such as ethane-1,2-diol, propane-1,2-diol and -1,3-diol, the isomeric butanediol, pentanediol, hexanediol, heptanediol and octanediol, decane-1,10-diol, dodecane-1,12-diol, cyclohexane-1,2-diol and -1,4-diol, cyclohexane-1,4-dimethanol, 4,4′-(1-methylethylidene)biscyclohexanol, diethylene glycol, triethylene glycol, tetraethylene glycol, propane-1,2-diol, dipropylene glycol, tripropylene glycol, tetrapropylene glycol, propane-1,2,3-triol, 1,1,1-trimethylolethane, hexane-1,2,6-triol, 1,1,1-trimethylolpropane, 2,2-bis(hydroxymethyl)propane-1,3-diol and/or 1,3,5-tris(2-hydroxyethyl) isocyanurate.

Suitable polyester polyols are for example also those that can be prepared in the customary manner from lactones and individual polyhydric alcohols, such as those listed above by way of example as starter molecules with ring opening. Examples of suitable lactones for preparing these polyester polyols are beta-propiolactone, gamma-butyrolactone, gamma- and delta-valerolactone, ε-caprolactone, 3,5,5- and 3,3,5-trimethylcaprolactone or any desired mixtures of such lactones.

Suitable polycarbonate polyols for producing the polyurethane dispersions B4) are in particular the reaction products known per se of dihydric alcohols, such as those mentioned above in the list of polyhydric alcohols, with diaryl carbonates such as diphenyl carbonate, dimethyl carbonate or phosgene. Further suitable polycarbonate polyols are those that contain not only carbonate structures but also ester groups. These are in particular the polyester carbonate diols known per se as obtainable for example according to the teaching of DE-B 1 770 245 by reacting dihydric alcohols with lactones, such as in particular ε-caprolactone, and then reacting the resulting polyester diols with diphenyl or dimethyl carbonate. Polycarbonate polyols that contain not only carbonate structures but also ether groups are likewise suitable. These are in particular the polyether carbonate polyols known per se as obtainable for example according to the method of EP-A 2046861 by catalytic reaction of alkylene oxides and carbon dioxide in the presence of H-functional starter molecules.

Suitable polyether polyols for producing the polyurethane dispersions B4) are for example those obtainable in a manner known per se by alkoxylation of suitable starter molecules. These polyether polyols may be prepared using as starter molecules any desired polyhydric alcohols, for example those from the molecular weight range from 62 to 400, of the type described above with regard to the preparation of polyester polyols. Alkylene oxides suitable for the alkoxylation reaction are in particular ethylene oxide and propylene oxide, which can be used in the alkoxylation reaction in any desired order or else in a mixture. Other polyether polyols that are likewise suitable are the polytetramethylene ether glycols prepared for example according to Angew. Chem. 72, 927 (1960) by polymerization of tetrahydrofuran and having number-average molecular weights of 400 g/mol to 4000 g/mol.

Suitable polyurethane dispersions B4) can additionally be produced using block copolymers based on the mentioned polyols, for example polyether-polyester copolymers, polycarbonate-polyester copolymers or polycarbonate-polyether copolymers.

Preferred polyols for producing suitable polyurethane dispersions B4) are polyester polyols, polycarbonate polyols and/or C3 and/or C4 polyether polyols.

The production of suitable polyurethane dispersions B4) may also optionally be carried out using low-molecular-weight alcohols having a functionality of 2 to 4. These are in particular compounds having a molecular weight of 500 g/mol, for example the simple polyhydric alcohols of the type mentioned above as synthesis components for polyester polyols, or amino alcohols such as diethanolamine, ethanolamine, diisopropanolamine or propanolamine, which may optionally also be present in ethoxylated and/or propoxylated form, and any mixtures of such alcohols.

The production of suitable polyurethane dispersions B4) is generally carried out using known compounds as chain extenders. These chain extenders are in particular diamines, polyamines and/or amino alcohols, for example diethanolamine, 1,2-diaminopropane, 1,4-diaminobutane, 2,5-diamino-2,5-dimethylhexane, 1,5-diamino-2-methylpentane, 1,6-diaminohexane, 2,2,4- and/or 2,4,4-trimethyl-1,6-diaminohexane, 1,11-diaminoundecane, 1,12-diaminododecane, triaminononane, ethylenediamine, isophoronediamine, diethylenetriamine, hydrazine, adipic dihydrazide, hydroxyethylethylenediamine, bishydroxyethylethylenediamine, aminopropanol, aminoalkoxysilanes, and any desired mixtures of such compounds.

Suitable polyurethane dispersions B4) can be produced using suitable solvents. Examples of suitable solvents are acetone, methyl ethyl ketone, N-methylpyrrolidone and/or N-ethylpyrrolidone.

Suitable polyurethane dispersions B4) may be produced in order to accelerate the reaction or to achieve specific effects, including using catalysts customary in polyurethane chemistry, such as dibutyltin dilaurate, dibutyltin oxide, tin dioctoate, tin chloride and/or tertiary amines.

In the production of the polyurethane dispersions in the melt or organic solution, diisocyanates and/or polyisocyanates are usually reacted with polyols and hydrophilic units of the stated type to form an isocyanate-functional prepolymer that is then reacted further, either in the melt, in organic solution or in aqueous dispersion, with a chain extender of the stated type to form a high-molecular-weight polyurethane that is dispersible and/or dispersed in water.

Any solvent used can be wholly or partially distilled off after the dispersion.

Suitable polyurethane dispersions B4) for the coating compositions of the invention preferably have solids contents of 25% to 60% by weight, a pH of 5.5 to 11 and/or average particle sizes of 20 to 500 nm.

Further suitable aqueous polymer dispersions B) for the formulations of the invention are polyester dispersions and polyester solutions B5), such as those obtained by dispersing suitable water-thinnable polyester polyols in water.

Examples of suitable water-thinnable polyester polyols are the dispersing resins known for example from paint technology, which have very good pigment wetting and/or pigment affinity qualities and acid values within a range from 25 to 75 mg KOH/g, hydroxyl group contents of 2.5% to 10% by weight, molecular weights within a range from 750 to 5000 g/mol and/or fatty acid constituents in amounts of 15% to 50% by weight.

Suitable polyester dispersions and solutions B5) for the formulations of the invention are obtained for example by reacting polyester polyols, for example as described above as synthesis components for the production of polyurethane dispersions B4), with acid anhydrides such as phthalic anhydride, hexahydrophthalic anhydride, tetrahydrophthalic anhydride, maleic anhydride, trimellitic anhydride or pyromellitic anhydride, the reaction being carried out such that the acid anhydrides react with some of the hydroxyl groups, with ring opening of the anhydride and incorporation into the polyester. This affords hydroxy-functional and at the same time carboxy-functional polyesters that, after complete or proportional neutralization of the carboxyl groups, can be dissolved or dispersed in water. Aqueous polyester dispersions or solutions B5) having average particle sizes of 10 to 200, preferably 25 to 100, nm are obtained.

Generally speaking, the aqueous polymer dispersions B) used in the coating compositions of the invention are dispersions of the stated type that are hydroxy- and/or amino-functional. However, it is also possible to use non-functional polymer dispersions B) as binder components in the coating compositions of the invention.

The aqueous polymer dispersion B) used in the coating compositions of the invention preferably comprises at least an aqueous secondary polyacrylate dispersion B1), a polyester-polyacrylate dispersion B3) based on polyester polyols, polycarbonate polyols and/or C₃ or C₄ polyether polyols.

In the coating compositions of the invention, preference is given to using hydroxy-functional aqueous polymer dispersions B) that, based on resin solids, have a hydroxyl group content of 0.5% to 7.0% by weight, preferably 0.5% to 6.0% by weight, more preferably 1.0% to 5.0% by weight, acid values of less than 50 mg KOH/g, preferably less than 40 mg KOH/g, more preferably less than 30 mg KOH/g and/or number-average molecular weights Mn, as determined by gel-permeation chromatography, of 500 to 30 000 g/mol, preferably 1000 to 15 000 g/mol, more preferably 1500 to 10 000 g/mol.

In the embodiment of the invention in which an aqueous 2-component formulation is present, there may additionally be at least one emulsifier present in component B. Suitable external and internal emulsifiers are known per se to those skilled in the art and described for example in “Polyurethanes—Coatings, Adhesives and Sealants”, 2019, Meier-Westhues, Danielmeier, Kruppa, Squiller, Vincentz Network GmbH, pp. 48-51. Particularly suitable emulsifiers contain either functional groups that can be converted into cations by neutralizing agents and/or quaternizing agents, and/or cationic groups or functional groups that can be converted into anions by neutralizing agents, and/or anionic groups, and/or nonionic hydrophilic groups.

The present invention further relates to the use of the NCO-terminated polysiloxane prepolymer of the invention as a curing agent in a paint formulation. What has been said as regards the 2-component formulation of the invention applies accordingly here in respect of amounts and further components present.

### EXAMPLES

All experiments were unless otherwise stated carried out at 23° C. and 50% relative humidity.

NCO contents were determined titrimetrically in accordance with DIN EN ISO 11909:2007-05.

OH values were determined titrimetrically in accordance with DIN 53240-2:2007-11.

Acid values were determined in accordance with DIN EN ISO 2114:2002-06.

The OH contents reported were calculated from the analytically determined OH values. The reported values are in each case based on the total weight of the respective composition including any solvent also used.

The residual monomer contents were measured according to DIN EN ISO 10283:2007-11 by gas chromatography with internal standard.

The solids content was determined in accordance with DIN EN ISO 3251:2008-06.

The drying times (T1, T3, and T4) were determined in accordance with DIN EN ISO 9117-5:2010-07 (drying tests—part 5: Modified Bandow-Wolff method).

The viscosity was determined at 23° C. in accordance with DIN EN ISO 3219/A:1994-10. Unless otherwise stated, this is the dynamic viscosity.

The number-average molecular weight Mn is determined by gel-permeation chromatography (GPC) in tetrahydrofuran at 23° C. The procedure is in accordance with DIN 55672-1:2016-03: “Gel-permeation chromatography, part 1—Tetrahydrofuran as elution solvent” (SECurity GPC System from PSS Polymer Service, flow rate 0.6 ml/min; columns: 2×PSS SDV (100 A), 2×PSS SDV (50 A), 8×300 mm, 5 μm; RID detector (RI-Agilent 1260). Polystyrene samples of known molar mass are used for calibration. The number-average molecular weight is calculated by the software.

The gloss at 20° of the coatings obtained was measured reflectometrically in accordance with DIN EN ISO 2813:2015-02.

The condensation water test was carried out in accordance with DIN EN ISO 6270-2 CH:2018-04.

The contact angle was determined in accordance with DIN 55660-2:2011-12. For each value, 10 points on the plate of the contact angle with water were examined and the average value of these measurements was reported.

The wet scratch resistance of the coatings was tested using a laboratory washing unit in accordance with DIN EN ISO 20566:2013-06. The value reported is the loss of gloss in gloss units (GU) after scratching (10 cycles). The lower the loss of gloss in GU, the more resistant the coating is to wet scratching.

The resistance to dry scratching was carried out using a linear stroke device (crockmeter) in accordance with DIN 55654:2015-08. A weight (950 g) covered on its flat underside with polishing paper (company 3M, grade: 9 MIC) was positioned on the coating without scratching the coating and then mechanically guided over the coating in one track. 10 or 20 back-and-forth strokes were each time executed. After the exposure to the scratching medium, the test area was cleaned with a soft cloth and the gloss then measured in three different places transverse to the direction of scratching. The lower the loss of gloss in GU, calculated from the average for this measurement, the more resistant the coating is to scratching.

König pendulum damping was determined in accordance with DIN EN ISO 1522:2007-04 on glass plates.

The described coatings were spray applied. The dry film thickness was for all films 35 to 40 μm.

Solvent and water resistances were determined in accordance with DIN EN ISO 4628-1:2016-07. The solvent resistance test was carried out using the solvents xylene (also abbreviated hereinafter as “Xy”), methoxypropyl acetate (MPA), ethyl acetate (EA), and acetone (Ac). The contact time was in each case 5 min. For the measurement of water resistances, the contact time was in each case 24 h. The inspection was carried out according to the specified standard. The test surface is assessed visually and by scratching, using the following classification: 0=no change apparent; 1=swelling ring, surface hard, only visible change; 2=swelling ring, slight softening; 3=distinct softening (possibly slight blistering); 4=significant softening (possibly severe blistering), can be scratched through to the substrate; 5=coating completely destroyed without external stressing.

The reflow describes the recovery of a scratched coating surface, based on the gloss value, after thermal stress. A coating composition is scratched by wet or dry scratching. The residual gloss was determined after the scratching cycle. The coating was placed in the oven at 60° C. for 2 h and the gloss then determined according to the procedure described above. The reflow is reported in percent, i.e. the ratio of residual gloss to reflow value.

The contact angle was carried out in accordance with DIN 55660-2:2011-12.

The examples and comparative examples employed the following reagents:

Diisocyanates:

Hexamethylene 1,6-diisocyanate (HDI) and isophorone diisocyanate (IPDI) were obtained from Covestro and used without purification.

Polyols:

Polyol 1 is based on a polyether diol (Dianol® 320 HP, solid), which contains secondary OH groups and has a hydroxyl value of 325 mg KOH/g). Reaction with propylene oxide gives polyol 1 having a molecular weight of 550 g/mol.

Polyol 2 is a polyester polyol formed from hexanediol, butanediol, adipic acid, and propanediol, having a functionality of 2, a molecular weight of approx. 400 g/mol, an OH content of approx. 8 wt, and a viscosity of 80 mPa·s

Polyol 3 is a polyacrylate polyol formed from methyl methacrylate, acrylic acid, styrene, and hydroxyethyl methacrylate that has an OH content of 2.8% by weight based on the solid substances, dissolved in butyl acetate with a solids content of 75% by weight. The viscosity is 5000 mPa·s.

Polyol 4 is an α,ω-hydroxypropyl-terminated polydimethylsiloxane (Baysilone OF OH 702 (4% by weight)) having an OH content of 4% by weight and a molecular weight of 600 to 800 g/mol. The clear liquid has a kinematic viscosity of 37 mm²·s⁻¹.

Polyol 5 is an aliphatic hydroxy-functional polycarbonate polyester polyurethane dispersion. It was obtained from Covestro and has the following properties:
Viscosity: 300-1500 mPa·s
Nonvolatiles content: 50.0-54.0%
OH content: approx. 1%

Polyol 6 is a polyester polyacrylate dispersion. It was obtained from Covestro and has the following properties:
Viscosity: 700-7200 mPa·s
Nonvolatiles content: 41-43%
OH content: 3.8%

Polyol 7 is a polyacrylate polyol. It was obtained from Allnex and is sold under the trade name Setalux DA 870 BA and has the following properties:
Viscosity: 3500 mPa·s
Nonvolatiles content: 70%
OH content: 4.2% (based on solids)

Amine 1 is a secondary amine produced from 4,4′-methylenebis(cyclohexylamine) and diethyl maleate and has the following properties:
Amine value: 200 mg KOH/g
Viscosity (25° C.): 900-2000 mPa·s
Color index (Hazen): ≤250

TMP stands for 1,1,1-trimethylolpropane, a trifunctional polyol having a molecular weight of 134 g/mol.

Polyisocyanates:

Polyisocyanate 1 is a trimer of hexamethylene 1,6-diisocyanate, having a functionality of 2.8 to 3.6, an NCO content of 23% by weight, an equivalent weight of 183 g/mol, and a viscosity of 1200 mPa·s.

Polyisocyanate 2 is a trimer of hexamethylene 1,6-diisocyanate, having a functionality of 2.8 to 3.6, an NCO content of 21.8% by weight, a viscosity of 3000 mPa·s, and an equivalent weight of 193 g/mol.

Polyisocyanate 3 is an allophanate based on hexamethylene 1,6-diisocyanate and propanol/butanol, having a functionality of 2.0 to 2.8, an equivalent weight of 215 g/mol, and a viscosity of 500 mPa·s.

Polyisocyanate 4 is a trimer of isophorone diisocyanate, having a functionality of 2.8 to 3.6, an NCO content of 11.9% by weight, a solids content of 70%, solvent naphtha 100 (30% by weight), an equivalent weight of 360 g/mol, and a viscosity of 1600 mPa·s.

Polyisocyanate 5 is an ionically hydrophilized polyisocyanate based on an HDI trimer and a sulfonate-based hydrophilizing agent, having a functionality of ≤2.8, an NCO content of 20.3% by weight, and a viscosity of 3500 mPa·s.

Additives and Catalysts:

Tinuvin 292, a mixture of bis(1,2,2,6,6-pentamethyl-4-piperidyl) sebacate (509 g/mol) and methyl 1,2,2,6,6-pentamethyl-4-piperidyl sebacate (370 g/mol), is a light stabilizer based on a sterically hindered amine. The viscosity is 400 mPa·s. The product was obtained from BASF and used without further purification.

Tinuvin 1130, a mixture of β-[3-(2H-benzotriazol-2-yl)-4-hydroxy-5-tert-butylphenyl]propionic acid poly(ethylene glycol) 300 ester (637 g/mol) and bis{b-[3-(2H-benzotriazole-2-yl)-4-hydroxy-5-tert-butylphenyl]propionic acid} poly(ethylene glycol) 300 ester (975 g/mol), is a UV absorber. The viscosity is 7400 mPa·s. The product was obtained from BASF and used without further purification.

BYK® 141 (solid, 96.8% as supplied), BYK® 331 (solid, 100% as supplied), and BYK® 348 (solid, 100% as supplied) are silicone-containing leveling agents formed from a siloxane and a polyether, covalently linked. The products were obtained from BYK.

Addocat® 201 is a standard catalyst based on dibutyltin dilaurate (DBTL), used in a concentration of 0.03% by weight on a solid binder. The catalyst was obtained from Lanxess.

Lucrafoam® DNE 01 is a mineral oil-based defoamer that is used in all pH ranges. The defoamer was obtained from Levaco Chemicals.

Tego®-Wet KL 245 is a siloxane-based wetting agent having an active content of 100%. It was obtained from Evonik Industries.

Aquacer 513 is a VOC-free HDPE-based wax emulsion used to improve surface protection in aqueous media. The wax emulsion was obtained from BYK.

Decosoft Transparent® 7 D is highly crosslinked aliphatic polyurethane particles (100%) that give the coating a soft-feel effect and a matt finish. The product was obtained from Microchem.

Matting agent Acematt® 3300 ACEMATT 3300 is a fumed silica that has been further treated with a special polymer. This matting agent is characterized by ultrahigh matting efficiency with high transparency.

Solvents such as butyl acetate (BA) and methoxypropyl acetate (MPA) were obtained from Azelis.

### Example 1 (Inventive)

An initial charge of 441 g of HDI was heated to 105° C. To this was added 280 g of Baysilone OFOH 702 and the reaction mixture was stirred for 3 h at 100° C. under a nitrogen atmosphere. After stirring for a further 2 h at 110° C., the unreacted HDI monomer was removed in a thin-film evaporator at a temperature of 150° C. and a pressure of 0.1 mbar. A practically colorless, clear NCO-terminated prepolymer having the following properties was obtained.
NCO content: 6.65% by weight
Solids content: 100%
Viscosity 320 mPa·s
HDI: <0.3% by weight

### Example 2 (Inventive)

An initial charge of 583 g of IPDI was heated to 105° C. To this was added 280 g of Baysilone OFOH 102 and the reaction mixture was stirred for 3 h at 100° C. under a nitrogen atmosphere. After stirring for a further 2 h at 110° C., the unreacted HDI monomer was removed in a thin-film evaporator at a temperature of 150° C. and a pressure of 0.1 mbar. A practically colorless, clear NCO-terminated prepolymer (425 g) having the following properties was obtained.
NCO content: 7.35% by weight
Solids content: 100%
Viscosity 3500
IPD: <0.3% by weight

### Example 3 (Comparative Example, One-Pot Reaction)

An initial charge of 756 g of Desmodur H was heated to 105° C. A mixture of 8 g of TMP, 33 g of polyol 1, and 120 g of polyol 4 was then added and the reaction mixture was stirred for 2 h at 110° C. under a nitrogen atmosphere. After stirring for a further 2 h at 110° C., the unreacted HDI monomer was removed in a thin-film evaporator at a temperature of 130° C. and a pressure of 0.1 mbar. A practically colorless, clear NCO-terminated prepolymer having the following properties was obtained.
NCO content: 9.5%
Solids content: 100%
Viscosity 960 mPa·s

### Example 4 (Inventive)

30.5 g of the product from example 1 was reacted with 21.3 g of polyol 2, 50% by weight solution in MPA, and in the presence of Addocat 201 (0.03% by weight). The reaction was carried out at 60° C. under a nitrogen atmosphere. Once the measured NCO content was less than 0.1% by weight, 55.5 g of Desmodur N3600 was added and the reaction mixture adjusted with MPA to a solids content of 50% by weight. The reaction was carried out at 60° C. until an NCO content of 4.9% by weight was attained. A practically colorless, clear NCO-terminated prepolymer having the following properties was obtained.
NCO content: 4.9%
Solids content: 50%
Viscosity 190 mPa·s

### Example 5 (Inventive)

15.25 g of the product from example 1 was reacted with 3.35 g of 1,1,1-trimethylolpropane, 50% by weight solution in MPA, in the presence of Addocat 201 (0.03% by weight). Once the measured NCO content was less than 0.1% by weight, 82.5 g of polyisocyanate 3 was added and the reaction mixture adjusted with MPA to a solids content of 50% by weight. The reaction was carried out at 60° C. with stirring until an NCO content of 6.8% by weight was attained. A practically colorless, clear NCO-terminated prepolymer having the following properties was obtained.
NCO content: 6.75% by weight
Solids content: 50% by weight
Viscosity 232 mPa·s

### Example 6 (Inventive)

15.3 g of the product from example 1 was reacted with 3.35 g of 1,1,1-trimethylolpropane, 50% by weight solution in MPA, in the presence of Addocat 201 (0.03% by weight). Once the measured NCO content was less than 0.1% by weight, 92.5 g of polyisocyanate 1 was added and the reaction mixture adjusted with MPA to a solids content of 50% by weight. The reaction was carried out at 60° C. with stirring until an NCO content of 8.5% by weight was attained. A practically colorless, clear NCO-terminated prepolymer having the following properties was obtained:
NCO content: 8.5% by weight
Solids content: 50% by weight
Viscosity 110 mPa·s

### Example 7 (Inventive)

5.28 g of the product from example 2 was reacted with 1.08 g of 1,1,1-trimethylolpropane, 50% by weight solution in MPA, in the presence of Addocat 201 (0.03% by weight). Once the measured NCO content was less than 0.1% by weight, 29.3 g of polyisocyanate 1 was added. The reaction mixture was adjusted with MPA to a solids content of 50% by weight. The reaction was carried out at 60° C. with stirring until an NCO content of 8.48% by weight was attained. A practically colorless, clear NCO-terminated prepolymer having the following properties was obtained:
NCO content: 8.48% by weight
Solids content: 50% by weight
Viscosity 175 mPa·s

### Example 8 (Inventive)

5.28 g of the product from example 2 was reacted with 1.08 g of 1,1,1-trimethylolpropane, 50% by weight solution in MPA, in the presence of Addocat 201 (0.03% by weight). Once the measured NCO content was less than 0.1% by weight, 32.8 g of polyisocyanate 5 was added and the reaction mixture adjusted with MPA to a solids content of 50% by weight. The reaction was carried out at 60° C. with stirring until an NCO content of 6.75% by weight was attained. A practically colorless, clear NCO-terminated prepolymer having the following properties was obtained:
NCO content: 6.75% by weight
Solids content: 50% by weight
Viscosity 145 mPa·s

### Example 9 (Inventive)

11.02 g of the product from example 2 was reacted with 2.24 g of 1,1,1-trimethylolpropane, 50% by weight solution in MPA, in the presence of Addocat 201 (0.03% by weight). Once the measured NCO content was less than 0.1% by weight, 120 g of polyisocyanate 4 was added and the reaction mixture adjusted with MPA to a solids content of 50% by weight. The reaction was carried out at 60° C. with stirring until an NCO content of 6.48% by weight was attained. A practically colorless, clear NCO-terminated prepolymer having the following properties was obtained:
NCO content: 6.48% by weight
Solids content: 50% by weight
Viscosity 180 mPa·s

### Example 10 (Inventive)

11.02 g of the product from example 2 was reacted with 108 g of polyol 2, 50% by weight solution in MPA, in the presence of Addocat 201 (0.03% by weight). Once the measured NCO content was less than 0.1% by weight, 120 g of polyisocyanate 4 was added and the reaction mixture adjusted with MPA to a solids content of 50% by weight. The reaction was carried out at 60° C. with stirring until an NCO content of 5.71% by weight was attained. A practically colorless, clear NCO-terminated prepolymer having the following properties was obtained:
NCO content: 5.71% by weight
Solids content: 50% by weight
Viscosity 30 mPa·s

### Example 11 (Inventive)

11.02 g of the product from example 2 was reacted with 40.5 g of polyol 3, 50% by weight solution in MPA, in the presence of Addocat 201 (0.03% by weight). Once the measured NCO content was less than 0.1% by weight, 120 g of polyisocyanate 4 was added and the reaction mixture adjusted with MPA to a solids content of 50% by weight. The reaction was carried out at 60° C. with stirring until an NCO content of 5.96% was attained. A practically colorless, clear NCO-terminated prepolymer having the following properties was obtained:
NCO content: 5.96% by weight
Solids content: 50% by weight
Viscosity 160 mPa·s

### Example 12 (Inventive)

6.76 g of the product from example 1 was reacted with 1.49 g of 1,1,1-trimethylolpropane, 50% by weight solution in MPA, in the presence of Addocat 201 (0.03% by weight). Once the measured NCO content was less than 0.1% by weight, 44.9 g of polyisocyanate 5 was added and the reaction mixture adjusted with MPA to a solids content of 50% by weight. The reaction was carried out at 60° C. with stirring until an NCO content of 7.82% by weight was attained. A practically colorless, clear NCO-terminated prepolymer having the following properties was obtained:
NCO content: 7.82% by weight
Solids content: 50.0% by weight
Viscosity 115 mPa·s

### Example 13 (Inventive)

6.76 g of the product from example 1 was reacted with 27.0 g of polyol 3 BA, 50% by weight solution in MPA, in the presence of Addocat 201 (0.03% by weight). Once the measured NCO content was less than 0.1% by weight, 44.9 g of polyisocyanate 5 was added and the reaction mixture adjusted with MPA to a solids content of 50% by weight. The reaction was carried out at 60° C. with stirring until an NCO content of 5.84% by weight was attained. A practically colorless, clear NCO-terminated prepolymer having the following properties was obtained:
NCO content: 5.84% by weight
Solids content: 50% by weight
Viscosity 100 mPa·s

### Example 14 (Inventive)

6.76 g of the product from example 1 was reacted with 7.17 g of polyol 2, 50% by weight in MPA, in the presence of Addocat 201. Once the measured NCO content was less than 0.1% by weight, 44.9 g of polyisocyanate 5 (0.03% by weight) was added and the reaction mixture adjusted with MPA to a solids content of 50% by weight. The reaction was carried out at 60° C. with stirring until an NCO content of 7.14% by weight was attained. A practically colorless, clear NCO-terminated prepolymer having the following properties was obtained:
NCO content: 7.14% by weight
Solids content: 50% by weight
Viscosity 70 mPa·s

### Example 15 (Inventive)

6.09 g of the product from example 1 was reacted with 24.3 g of polyisocyanate 3, 50% by weight in MPA, in the presence of Addocat 201 (0.03% by weight). Once the measured NCO content was less than 0.1% by weight, 38.6 g of polyisocyanate 2 was added and the reaction mixture adjusted with MPA to a solids content of 50% by weight. The reaction was carried out at 60° C. with stirring until an NCO content of 6.75% by weight was attained. A practically colorless, clear NCO-terminated prepolymer having the following properties was obtained:
NCO content: 6.75% by weight
Solids content: 50% by weight
Viscosity 110 mPa·s

### Example 16 (Inventive)

6.09 g of the product from example 1 was reacted with 1.34 g of 1,1,1-trimethylolpropane, 50% by weight in MPA, in the presence of Addocat 201 (0.03% by weight). Once the measured NCO content was less than 0.1% by weight, 38.6 g of polyisocyanate 2 was added and the reaction mixture adjusted with MPA to a solids content of 50% by weight. The reaction was carried out at 60° C. with stirring until an NCO content of 6.75% by weight was attained. A practically colorless, clear NCO-terminated prepolymer having the following properties was obtained:
NCO content: 6.75% by weight
Solids content: 50% by weight
Viscosity 200 mPa·s

### Example 17 (Inventive)

6.09 g of the product from example 1 was reacted with 6.45 g of polyol 2, 50% by weight in MPA, in the presence of Addocat 201 (0.03% by weight). Once the measured NCO content was less than 0.1% by weight, 38.6 g of polyisocyanate 2 was added and the reaction mixture adjusted with MPA to a solids content of 50% by weight. The reaction was carried out at 60° C. with stirring until an NCO content of 6.75% by weight was attained. A practically colorless, clear NCO-terminated prepolymer having the following properties was obtained:
NCO content: 6.75% by weight
Solids content: 50% by weight
Viscosity 90 mPa·s

### Example 17 (Inventive)

12.63 g of the product from example 1 was stirred with 16.56 g of amine 1 and at RT for 8 h. 77.20 g of polyisocyanate 2 was then added and the mixture likewise stirred at RT for 8 h. A practically colorless, clear NCO-terminated prepolymer having the following properties was obtained:
NCO content: 7.01% by weight
Solids content: 50% by weight
Viscosity 100 mPa·s

### Use Examples

Table 1 presents various paint systems. The components of the paint formulations were mixed with one another and applied by means of a spray application process on glass and basecoat (multilayer construction). The coated specimens are dried at 60° C. for 30 min.

TABLE 1
The formulations were spray-applied and baked at 60° C.
for 30 min. All analytical values were determined after 7 days.

| | | | | | | | Byk | Byk |
|---|---|---|---|---|---|---|---|---|
| Example | Xylene | MPA | Butyl | Addocat | Tinuvin | Tinuvin | 331 | 141 |
| 50 | 0 | 0 | 0 | 1 | 50 | 50 | 10 | 96.8 |
| — | 10.60 | 6.44 | 10.60 | 1.50 | 2.00 | 1.00 | 1.50 | 0.25 |
| — | 10.60 | 6.44 | 10.60 | 1.50 | 2.00 | 1.00 | — | — |
| — | 10.09 | 6.15 | 10.09 | 1.50 | 2.00 | 1.00 | 1.50 | 0.25 |
| — | 10.09 | 6.15 | 10.09 | 1.50 | 2.00 | 1.00 | — | — |
| — | 9.95 | 6.06 | 9.95 | 1.50 | 2.00 | 1.00 | 1.50 | 0.25 |
| — | 9.95 | 6.06 | 9.95 | 1.50 | 2.00 | 1.00 | — | — |
| — | 11.08 | 6.74 | 11.08 | 1.50 | 2.00 | 1.00 | 1.50 | 0.25 |
| — | 11.08 | 6.74 | 11.08 | 1.50 | 2.00 | 1.00 | — | — |
| 2.39 | 11.23 | 6.86 | 11.23 | 1.5 | 2.00 | 1.00 | 1.50 | 0.25 |
| | | | | | Polyiso- | | | |
| | | Polyol | | | cyanate | | | |
| | | 7 | Product | | 1 | Example | Example | Example |
| | | 70 | Solids | | 100 | 50 | 50 | 50 |
| | | 48.33 | Weight (g) | Paint 1 | 14.71 | — | — | 3.07 |
| | | 48.33 | Weight (g) | Paint 2 | 14.71 | — | — | 3.07 |
| | | 47.96 | Weight (g) | Paint 3 | 13.55 | — | 5.91 | — |
| | | 47.96 | Weight (g) | Paint 4 | 13.55 | — | 5.91 | — |
| | | 48.37 | Weight (g) | Paint 5 | 13.03 | 6.39 | — | — |
| | | 48.37 | Weight (g) | Paint 6 | 13.03 | 6.39 | — | — |
| | | 49.21 | Weight (g) | Paint 7 | 15.63 | — | — | — |
| | | | | (comp.) | | | | |
| | | 49.21 | Weight (g) | Paint 8 | 15.63 | — | — | — |
| | | | | (comp.) | | | | |
| | | 47.82 | Weight (g) | Paint 9 | 14.11 | — | — | — |
| | | | | (comp.) | | | | |

comp. = comparative example

For the various paint formulations, the contact angle against H₂O after spray application was determined. For paint 1 (with leveling agent) in comparison to paint 2 (without leveling agent), it is shown here by way of example that the employed silicone-containing leveling agents have no effect on the contact angle, since the values are of the same order (97° and 100° respectively) and are accordingly comparable. For paint 1 to paint 5 it has been shown that the addition of NCO-terminated prepolymers containing siloxane chains is able to achieve an increase in contact angle without affecting customary paint parameters such as gloss.

In addition, only a slight fluctuation in contact angle is observed after dry scratching and, surprisingly, in the condensation water test (SWT). The observed results show marked differences from the comparisons paint 8 and paint 9, which contain no NCO-terminated, siloxane-containing prepolymers; these have a contact angle that is approx. 20° low. Comparative example paint 9 does also comprise siloxane-terminated prepolymer, but this has a different composition. As a consequence, a decrease in contact angle is observed in the condensation water test.

TABLE 2
Determination of the contact angle of various
clearcoats before and after stressing by
scratching and condensation water test (SWT).

| Contact | | | | | | | |
|---|---|---|---|---|---|---|---|
| angle | Paint | Paint | Paint | Paint | Paint 7^{[1]} | Paint 8 | Paint 9 |
| H₂O [°] | 1^{[1]} | 2 | 3^{[1]} | 5^{[1]} | (comp.) | (comp.) | (comp.) |
| Basecoat | 97 | 100 | 96 | 96 | 83 | 80 | 101 |
| (before) | | | | | | | |
| After PP | 94 | 93 | 95 | 94 | 82 | 80 | — |
| and reflow | | | | | | | |
| (2 h 60° C.) | | | | | | | |
| After SWT^{[2]} | 97 | 95 | 96 | 95 | 73 | 74 | 913 |
| Δ | 0 | 5 | 0 | 3 | 30 | 6 | 10 |

^{[1]}with leveling agent.
^{[2]}SWT = condensation water test.

The siloxane-containing coatings were surprisingly observed to have better reflow by comparison with the comparative examples. This is explained by way of example by comparing paint 3 with paint 7. After dry scratching, the gloss for both clearcoats falls—from the same baseline value—to approx. 11 gloss units. After reflow, a value of 87 gloss units is obtained for paint 3, whereas for paint 7 a value of only 77 gloss units is observed.

TABLE 3
Dry scratching using a hammer for various paint systems.
Reflow: 2 h, 60° C. All paint systems comprise leveling agents.

| Dry scratching | | | | | |
|---|---|---|---|---|---|
| with a hammer | Paint 1 | Paint 3 | Paint 5 | Paint 7 | Paint 9 |
| Gloss 20° before | 91.1 | 91.1 | 91.4 | 91.4 | 89.6 |
| Gloss 20° afterwards | 11.2 | 11.5 | 11.5 | 11.0 | 9.9 |
| Residual gloss after | 12.3 | 12.6 | 12.6 | 12.0 | 11.0 |
| PP [%] | | | | | |
| Gloss 20° reflow | 86.1 | 87.3 | 85.8 | 70.4 | 77.3 |
| Residual gloss after | 94.5 | 95.8 | 93.9 | 77.0 | 86.3 |
| reflow [%] | | | | | |

Table 4 compares paint systems that all comprise leveling additives. Here, too, it is clearly evident that the siloxane-containing systems have markedly better residual gloss and reflow (e.g. paint 6 vs. paint 8).

TABLE 4
Dry scratching using a crockmeter for various paint systems.
Reflow: 2 h, 60° C. All paint systems contain no leveling agents.

| Dry scratching | | | | |
|---|---|---|---|---|
| using crockmeter | Paint 2 | Paint 4 | Paint 6 | Paint 8 |
| Gloss 20° before | 91 | 91 | 91 | 92 |
| Gloss 20° afterwards | 42 | 34 | 38 | 15 |
| Residual gloss after | 46 | 37 | 42 | 16 |
| PP [%] | | | | |
| Gloss 20° reflow | 81 | 69 | 63 | 29 |
| Residual gloss after | 89 | 76 | 70 | 46 |
| reflow [%] | | | | |

A further surprising beneficial effect observed through addition of the NCO-terminated siloxane prepolymers was an improved appearance: The coating of the standard formulation forms in the absence of leveling additives an “orange peel” surface. When the NCO-terminated siloxane prepolymers of the invention were used and leveling additives omitted, no orange peel was observed. The addition of the NCO-terminated siloxane prepolymers of the invention thus eliminates the need for additives in the clearcoat, without this being accompanied by orange peel formation.

In addition, the compatibility of the NCO-terminated polysiloxane prepolymers was investigated. This is illustrated using the formulations shown in Table 5 by way of example.

TABLE 5
Paint formulations with increased NCO-terminated siloxane content.

| | Paint 10 | Paint 11 | Paint 12 |
|---|---|---|---|
| PIC/NCO-siloxane | 8:2 | 7:3 | 6:4 |
| (binder solid-on-solid) | | | |
| Polyol 7 | 50.86 | 47.54 | 44.23 |
| Tinuvin 292 | 1.08 | 1.04 | 0.99 |
| Tinuvin 1130 | 2.16 | 2.08 | 1.98 |
| Addocat 201 | 1.62 | 1.55 | 1.38 |
| BA/MPA/XY | 33.28 | 29.27 | 27.51 |
| Example 4 | 7.40 | 11.10 | 14.80 |
| Polyisocyanate 1 | 14.80 | 12.95 | 11.10 |
| Solids (%) | 50% | 50% | 50% |

As shown in Table 6, the new paint raw materials could be used over a broad concentration range.

TABLE 6
Spray-painting of paint 10 and paint 11

| | Paint 10 | Paint 11 | Paint 12 |
|---|---|---|---|
| Optical properties | Clear | Clear | Clear |
| Spray optics | Smooth | Smooth | Smooth |
| Gloss (20°/60°) | 91/94 | 92/95 | 90/94 |
| Haze | 11 | 11 | 10 |
| Solvent resistances | 2244 | 2244 | 2244 |
| Xy-MPA-EA-Ac (5 min) | | | |

The following example examined the suitability of the new siloxane-containing paint raw materials in water-based paints. The corresponding formulations are given in Table 7.

TABLE 7
2C water-based paints for soft-feel coatings

| | Solids | Paint 13 (comp.) | Paint 14 |
|---|---|---|---|
| | content | Weight | Weight |
| Product | [%] | [g] | (g) |
| Polyol 5 | 52 | 25 | 25 |
| Polyol 6 | 42 | 31 | 31 |
| Dist. water | 0 | 13.7 | 13.7 |
| Lucrafoam DNE 01 | 100 | 0.2 | 0.2 |
| Tego-Wet KL 245 | 50 | 0.4 | 0.4 |
| Byk 348 | 100 | 0.6 | 0.6 |
| Aquacer 513 | 35 | 1.7 | 1.7 |
| Decosoft Transparent 7 D | 100 | 7.7 | 7.7 |
| Matting agent Acematt 3300 | 100 | 3.1 | 3.1 |
| Polyisocyanate 5 | 100 | 4.98 | 4.98 |
| Example 4 | 50 | — | 1.87 |
| Polyisocyanate 1 | 100 | 11.62 | 11.62 |

In these studies, the guideline formulation was retained unchanged and the novel, highly compatible NCO-terminated siloxanes additionally added. The tests showed that an identical mail paint appearance was obtained. The contact angle measurements showed that the contact angle could be increased from 90° to 110°.

TABLE 8
Water-based paints were applied by spray application, substrate glass.

| | Paint 13 (comp.) | Paint 14 |
|---|---|---|
| Film appearance | Matt, like | Matt, like |
| | paint 14 | paint 13 |
| Contact angle H₂O [°] | 89.6 | 111 |

1: An NCO-terminated polysiloxane prepolymer of the general formula (I)
[(Q)_{q}]-[(M)ₘ-(P)ₚ—(R)ᵣ]ₜ (I),
wherein R, P, M, Q, r, p, m, q, and t are defined as follows
R in each case independently comprises at least one polyisocyanate unit and/or at least one diisocyanate unit,
P in each case independently comprises at least one polyol unit,
M in each case independently comprises at least one diisocyanate unit and/or at least one polyisocyanate unit,
Q comprises at least one polysiloxane unit,
r in each case independently is a number from 1 to 10,
p in each case independently is a number from 1 to 10,
m in each case independently is a number from 1 to 10,
q in each case independently is a number from 1 to 10,
t is an integer from 2 to 5, and
the units M are attached directly to the unit Q.

2: The polysiloxane prepolymer as claimed in claim 1, characterized in that the at least one polyisocyanate unit R is selected from the group consisting of 3,5,5-trimethyl-1-isocyanato-3-isocyanatomethylcyclohexane higher-molecular-weight oligomers having biuret, uretdione, isocyanurate, iminooxadiazinedione, allophanate, urethane- and/or carbodiimide/uretonimine structural units obtainable through reaction of di- or triisocyanates selected from the group consisting of butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′-, and 4,4′-MDI or mixtures thereof), diisocyanatomethylbenzene (tolylene 2,4- and 2,6-diisocyanate, TDI) and technical mixtures of the two isomers and 1,3- and/or 1,4-bis(isocyanatomethyl)benzene (XDI), 3,3′-dimethylbiphenyl 4,4′-diisocyanate (TODI), 1,4-para-phenylene diisocyanate (PPDI), cyclohexyl diisocyanate (CHDI), and mixtures thereof.

3: The polysiloxane prepolymer as claimed in claim 1, characterized in that the at least one polyol unit P is selected from the group consisting of polyether polyols, polyester polyols, polyurethane polyols, polysiloxane polyols, polycarbonate polyols, polybutadiene polyols, polyacrylate polyols, polymethacrylate polyols, copolymers of polyacrylate polyols, polymethacrylate polyols, and mixtures thereof.

4: The polysiloxane prepolymer as claimed in claim 1, characterized in that M is at least one diisocyanate unit selected from the group consisting of butane 1,4-diisocyanate, pentane 1,5-diisocyanate (pentamethylene diisocyanate, PDI), hexane 1,6-diisocyanate (hexamethylene diisocyanate, HDI), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′-, and 4,4′-MDI or mixtures thereof), diisocyanatomethylbenzene (tolylene 2,4- and 2,6-diisocyanate, TDI) and mixtures of those two isomers, 1,3- and/or 1,4-bis(isocyanatomethyl)benzene (XDI), 3,3′-dimethylbiphenyl 4,4′-diisocyanate (TODI), 1,4-para-phenylene diisocyanate (PPDI), cyclohexyl diisocyanate (CHDI), and mixtures thereof.

5: The polysiloxane prepolymer as claimed in claim 1, characterized in that the at least one polysiloxane unit Q is derived from one selected from the group consisting of a polysiloxane polyol, a polysiloxane polyamine, and a polysiloxane polythiol.

6: The polysiloxane prepolymer as claimed in claim 1, characterized in that the at least one polysiloxane unit is present in an amount of from 0.1% to 5% by weight based on the total polysiloxane prepolymer.

7: The polysiloxane prepolymer as claimed in claim 1, characterized in that the polysiloxane prepolymer has a number-average molecular weight Mn of <4000 g/mol, preferably of >450 g/mol and <3000 g/mol, particularly preferably of >650 g/mol and <2500 g/mol, and very particularly preferably of >800 g/mol and <2500 g/mol.

8: A process for preparing the NCO-terminated polysiloxane prepolymer as claimed in claim 1, comprising the following steps:
(A) reacting at least one of a polysiloxane polyol, a polysiloxane polyamine and a polysiloxane polythiol with at least one diisocyanate and/or at least one polyisocyanate to obtain at least one NCO-terminated polysiloxane,
(B) optionally, removing the excess of at least one diisocyanate and/or at least one polyisocyanate,
(C) reacting the at least one NCO-terminated polysiloxane from step (A) or (B) with at least one polyol to form a product,
(D) reacting the product obtained in step (C) with at least one diisocyanate or at least one polyisocyanate to obtain the NCO-terminated polysiloxane prepolymer.

9: The process as claimed in claim 8, characterized in that step (B) is carried out by one selected from the group consisting of thin-film evaporation, phase separation, precipitation, and combinations thereof.

10: The process as claimed in claim 8, characterized in that, after step (B), the content in the reaction mixture of the at least one diisocyanate or the at least one polyisocyanate is not more than 5% by weight.

11: A formulation comprising at the least one NCO-terminated polysiloxane prepolymer as claimed in claim 1, in an amount of from 5% to 70% by weight based on the weight of the formulation.

12: The formulation as claimed in claim 11, characterized in that it is a paint formulation.

13: A curing agent in a paint formulation comprising the NCO-terminated polysiloxane prepolymer as claimed in claim 1.

14: The polysiloxane prepolymer as claimed in claim 1, characterized in that the polysiloxane prepolymer has a number-average molecular weight Mn of >450 g/mol and <3000 g/mol.

15: The polysiloxane prepolymer as claimed in claim 1, characterized in that the polysiloxane prepolymer has a number-average molecular weight Mn of >650 g/mol and <2500 g/mol.

16: The polysiloxane prepolymer as claimed in claim 1, characterized in that the polysiloxane prepolymer has a number-average molecular weight Mn of >800 g/mol and <2500 g/mol.
